(19) United States
(12) Patent Application Publication
(10) Pub. No.: US 2025/0001523 A1
(43) Pub. Date: Jan. 2, 2025

(54) Method for laser processing wafer surface and laser processing system

(71) Applicant: Tripod Technology Corporation, Taoyuan City (TW)

(72) Inventors: Pai-Chun CHANG, Taoyuan City (TW); Sheng-Ru LEE, Taoyuan City (TW); Yung-Hsiang HUANG, Taoyuan City (TW); Su SHANG, Taoyuan City (TW); Jiunn-Yih CHYAN, Taoyuan City (TW)

(21) Appl. No.: 18/753,060

(22) Filed: Jun. 25, 2024

(30) Foreign Application Priority Data
Jun. 30, 2023 (TW) 112124596

(51) Int. Cl. B23K 26/352; B23K 26/06; B23K 26/0622; B23K 26/073; B23K 26/08; B23K 26/082; B23K 103/00

(52) U.S. Cl. CPC B23K 26/3576; B23K 26/0622; B23K 26/0626; B23K 26/073; B23K 26/082; B23K 26/0823; B23K 2103/56

(57) ABSTRACT

A method for laser processing wafer surface comprises following steps of: providing a wafer; performing profile scanning a top surface of the wafer by a scanning device to obtain a profile distribution of the top surface of the wafer; and performing laser processing on the wafer from the top surface of the wafer by a laser apparatus with a fluence integration distribution to form a laser-processed wafer, wherein the fluence integration distribution is related to the profile distribution of the top surface of the wafer.

### FIELD OF THE INVENTION

The present invention is related to a method for laser processing wafer surface and laser processing system, especially the method for laser processing wafer surface and laser processing system performing laser processing with a fluence integration distribution according to the scanned profile distribution of the top surface of the wafer.

### BACKGROUND OF THE INVENTION

Please refer to FIG. 18A, which is a cross-sectional schematic view of the profile distribution of the top surface of the SiC wafer which has not yet been lapped in conventional technology. In conventional technology, after the SiC wafers 9 have been cut into slices from the SiC ingot, since SiC is a very hard material, the cutting surface (for example, the top surface) of the SiC wafer 9 is usually very uneven (a top surface 90 of the SiC wafer 9, as shown in FIG. 18A). A bottom of the SiC wafer 9 is usually not a flat plane as shown in FIG. 18A, and is usually also very uneven. Before the lapping process, the top surface 90 of the SiC wafer 9 has higher profile distribution in some regions (for example, a region 95 of FIG. 18A) and lower profile distribution in some regions (for example, a region 96 of FIG. 18A). Therefore, in conventional technology, the top surface 90 of the SiC wafer 9 usually needs to be subjected to a lapping process first. After the lapping process, the top surface 90 of the SiC wafer 9 usually needs to be subjected to a polishing process. Only then can the top surface 90 of the SiC wafer 9 be finely polished for use in the wafer processing factory. However, since SiC is very hard, lapping the top surface 90 of the SiC wafer 9 in convention technology usually is very time consuming, high abrasives consumption and very costly. For example, lapping process a top surface 90 of a SiC wafer 9 usually takes dozens of hours. Therefore, in addition to time consuming, the production capacity of each lapping process machine is also severely limit. The longer it takes, the higher the abrasives consume.

In addition, in convention technology, after the SiC wafers have been cut into slices from the SiC ingot, a laser is first used to comprehensively and uniformly process the top surface of the SiC wafer before lapping the SiC wafer, such that the SiC wafer adjacent to the top surface of the SiC wafer is modified and becomes less hard, and the modified part of the SiC wafer adjacent to the top surface of the SiC wafer forms a modified layer. Please refer to FIG. 18B, which is a cross-sectional schematic view of the SiC wafer after being a shallower degree of laser modification on the top surface of the SiC wafer in FIG. 18A. After the top surface 90 of the SiC wafer 9 in FIG. 18A is shallower degree modified by laser processing, the modified portion of the SiC wafer 9 adjacent to the top surface 90 of the SiC wafer 9 forms a modified layer 91 (as shown in FIG. 18B). During the process of modifying the SiC wafer adjacent to the top surface of the SiC wafer by laser processing in the conventional technology, the profile distribution of the top surface 90 of the SiC wafer 9 will not take into account. Therefore, no matter it is in a region 95 with very high profile distribution or in a region 96 with very low profile distribution, a thickness of the modified layer 91 is approximately the same. When the lapping process is performed at the beginning, only the modified layer 91 near the region 95 with very high profile distribution will be lapped (other portions are not lapped because their profile distribution are relative low). Since the modified layer 91 is not as hard as the SiC wafer 9, lapping the portion of the modified layer 91 is much easier and not time consuming or not so high abrasives consumption than lapping the very hard SiC wafer 9 (not modified yet). Please also refer to FIG. 18C, which is a cross-sectional schematic view of the SiC wafer after the top surface of the SiC wafer in FIG. 18B further being a short period of lapping process (not the complete lapping process). However, after lapping for a period of time, the modified layer 91 near the region 95 was removed by lapping process, so that the unmodified SiC wafer 9 near the region 95 is exposed through a lapped surface 92 (as shown in FIG. 18C). Then continue the lapping process, the unmodified SiC wafer 9 exposed through the lapped surface 92 will be lapped. The lapping process must be carried out at least until the modified layer 91 near the region 96 with very low profile distribution is removed by lapping process, and the unmodified SiC wafer 9 is exposed near the region 96. During the lapping process from the moment the unmodified SiC wafer 9 near the region 95 is exposed through the lapped surface 92 to the moment the unmodified SiC wafer 9 near region 96 is exposed, there are a lot of portions of the unmodified SiC wafer 9 were lapped due to the lapping process (for example, the portions of the unmodified SiC wafer 9 on the left and right sides of the region 96). Therefore, the lapping process during this period is very time consuming and high abrasives consumption.

Please refer to FIG. 18D, which is a cross-sectional schematic view of the SiC wafer after being a deeper degree of laser modification on the top surface of the SiC wafer in FIG. 18A. In conventional technology, when comprehensively and evenly performing laser process on the top surface 90 of the SiC wafer 9, if the laser processing is performed with a higher laser fluence, then a thicker modified layer 93 (as shown in FIG. 18D) will be formed. A thickness of the modified layer 93 in FIG. 18D is greater than a thickness of the modified layer 91 in FIG. 18B. Similarly, no matter it is in the region 95 with very high profile distribution or in the region 96 with very low profile distribution, a thickness of the modified layer 93 is approximately the same. When the lapping process is performed at the beginning, only the modified layer 93 near the region 95 with very high profile distribution will be lapped (other portions are not lapped because their profile distribution are relative low). Then the modified layer 93 near the left side of the region 96 also begins to be lapped, while the modified layer 93 near the region 96 is still not lapped yet because its profile distribution is relatively low. Since the modified layer 93 is not as hard as the SiC wafer 9, lapping the portion of the modified layer 93 is much easier and not time consuming or not so high abrasives consumption than lapping the portion of the very hard SiC wafer 9 (not modified yet). Please also refer to FIG. 18E, which is a cross-sectional schematic view of the SiC wafer after the top surface of the SiC wafer in FIG. 18D further being a short period of lapping process (not the complete lapping process). However, after lapping for a period of time, the modified layer 93 near the region 95 and the modified layer 93 near the left side of the region 96 were removed by lapping process, so that the unmodified SiC wafer 9 near the region 95 and the unmodified SiC wafer 9 near the left side of the region 96 are exposed through a lapped surface 94 (as shown in FIG. 18E). Then continue the lapping process, the unmodified SiC wafer 9 exposed through the lapped surface 94 will be lapped. The lapping process must be carried out at least until the modified layer 93 near the region 96 with very low profile distribution is removed by lapping process, and the unmodified SiC wafer 9 is exposed near the region 96. During the lapping process from the moment the unmodified SiC wafer 9 near the region 95 is exposed through the lapped surface 94 to the moment the unmodified SiC wafer 9 near region 96 is exposed, some portions of the unmodified SiC wafer 9 were lapped due to the lapping process.

Compare the time consumption of the lapping process and the overall loss rate of the SiC wafer 9 in the embodiment of FIGS. 18B and 18C and the embodiment of FIGS. 18D and 18E. The modified layer 91 in the embodiment of FIGS. 18B and 18C is thinner than the modified layer 93 in the embodiment of FIGS. 18D and 18E. During the lapping process from the very beginning to the moment the unmodified SiC wafer 9 near region 96 is exposed, less portions of the SiC wafer 9 (including the modified portion and the unmodified portion) were lapped in the embodiment of FIGS. 18B and 18C than that in the embodiment of FIGS. 18D and 18E. Therefore, the overall loss rate of the SiC wafer 9 in the embodiment of FIGS. 18B and 18C is lower than that in the embodiment of FIGS. 18D and 18E; however, the lapping process in the embodiment of FIGS. 18B and 18C is more time consuming and high abrasives consumption than that in the embodiment of FIGS. 18D and 18E. Although the time consumption and the abrasives consumption are less, but the overall loss rate of the SiC wafer 9 in the embodiment of FIGS. 18D and 18E is higher; that is, the SiC wafer 9 with a thicker thickness is needed when cutting the SiC ingot into the SiC wafers 9. As a result, the number of the SiC wafers 9 that can be cut from the SiC ingot is reduced, and the cost naturally increases significantly.

### SUMMARY OF THE INVENTION

The main technical problems that the present invention is seeking to solve is how to provide a method for laser processing wafer surface that can enhance laser modification in regions where the profile distribution of the top surface of the wafer is higher, and reduce laser modification in regions where the profile distribution of the top surface of the wafer is lower, in order to improve the lapping process which is time consuming and high abrasives consumption, and at the same time reduce the overall loss rate of the wafer.

In order to solve the above described problems and to achieve the expected effect, the present invention provides a method for laser processing wafer surface, which comprises following steps of: Step A: providing a wafer; Step B: performing profile scanning a top surface of the wafer by a scanning device to obtain a profile distribution of the top surface of the wafer; and Step C: performing laser processing on the wafer from the top surface of the wafer by a laser apparatus with a fluence integration distribution to form a laser-processed wafer, wherein the fluence integration distribution is related to the profile distribution of the top surface of the wafer.

Furthermore, the present invention also provide a laser processing system for wafer surface, which comprises a motion driving apparatus, a carrying device, a scanning device and a laser apparatus. The carrying device is disposed on the motion driving apparatus. The carrying device is used for carrying a wafer. The motion driving apparatus enables at least one of a relative displacement and a relative rotation between the scanning device and the wafer. The scanning device is used for scanning a top surface of the wafer to obtain a profile distribution of the top surface of the wafer. The motion driving apparatus enables at least one of a relative displacement and a relative rotation between the laser apparatus and the wafer. The laser apparatus is used for performing laser processing on the wafer from the top surface of the wafer with a fluence integration distribution to form a laser-processed wafer, wherein the fluence integration distribution is related to the profile distribution of the top surface of the wafer.

In implementation, the fluence integration distribution and the profile distribution meet one of the following conditions: (1) the first condition: where the profile distribution is higher, the fluence integration distribution is approximately higher, (2) the second condition: the profile distribution has a maximum value and a minimum value, a difference of the maximum value and the minimum value is defined as a high-low range of the profile distribution, a difference of the profile distribution and the minimum value is defined as a normalized profile distribution, a ratio of the normalized profile distribution to the high-low range is defined as a normalized-profile proportion distribution, wherein the fluence integration distribution is approximately proportional to the normalized-profile proportion distribution, (3) the third condition: where the profile distribution is smaller than or equal to a minimum height threshold, the fluence integration distribution is approximately equal to a minimum fluence integration threshold, wherein the minimum fluence integration threshold is greater than or equal to zero, (4) the fourth condition: where the profile distribution is smaller than or equal to a minimum height threshold, the fluence integration distribution is approximately equal to a minimum fluence integration threshold, wherein the minimum fluence integration threshold is greater than or equal to zero; while the profile distribution is greater than the minimum height threshold, where the profile distribution is higher, the fluence integration distribution is approximately higher, (5) the fifth condition: where the profile distribution is higher, the fluence integration distribution is approximately lower, and (6) the sixth condition: the profile distribution has a maximum value and a minimum value, a difference of the maximum value and the minimum value is defined as a high-low range of the profile distribution, a difference of the profile distribution and the minimum value is defined as a normalized profile distribution, a ratio of the normalized profile distribution to the high-low range is defined as a normalized-profile proportion distribution, wherein the fluence integration distribution is approximately inversely proportional to the normalized-profile proportion distribution.

In implementation, the motion driving apparatus comprises a scanning motion driving device and a processing motion driving device. The carrying device comprises a scanning wafer carrier disposed on the scanning motion driving device and a processing wafer carrier disposed on the processing motion driving device. The scanning motion driving device enables at least one of a relative displacement and a relative rotation between the scanning device and the wafer when the wafer is carried by the scanning wafer carrier. The processing motion driving device enables at least one of a relative displacement and a relative rotation between the laser apparatus and the wafer when the wafer is carried by the processing wafer carrier.

In implementation, the fluence integration distribution is capable of being controlled by controlling at least one of a laser pulse integration distribution and a fluence of the laser apparatus.

In implementation, the fluence of the laser apparatus is greater than or equal to a minimum fluence threshold.

In implementation, the minimum fluence threshold is at least related to a wavelength of the laser apparatus and a material that the wafer is made of.

In implementation, the fluence of the laser apparatus is capable of being controlled by controlling at least one of a pulse repetition rate of the laser apparatus, a power of the laser apparatus and a spot area of a laser pulse generated by the laser apparatus on a focal plane of the laser pulse.

In implementation, the laser pulse integration distribution is capable of being controlled by controlling at least one of an overlapping rate of a plurality of laser pulses generated by the laser apparatus along a laser processing path direction and an overlapping rate of the plurality of laser pulses generated by the laser apparatus along a separation direction of two adjacent laser processing paths.

In implementation, the laser processing system for wafer surface further comprises a coating device. The coating device comprises a coating wafer carrier. The coating device is used for carrying the wafer by the coating wafer carrier and coating an assisted modifying layer on the top surface of the wafer before performing laser processing on the wafer by the laser apparatus.

In implementation, before the Step C, the method further comprises a following step of: coating an assisted modifying layer on the top surface of the wafer.

In implementation, the assisted modifying layer is made of at least one material selected from the group consisting of: (1) a mixture of a solution containing metal ions, an oxidant and a buffer, (2) an alkaline solution or colloid, and (3) at least one of a sol-gel containing at least one metal and a sol-gel containing an oxide of the at least one metal.

In implementation, the assisted modifying layer is made of the mixture of the solution containing metal ions, the oxidant and the buffer; wherein the solution containing metal ions is made of at least one material selected from the group consisting of: a solution of Ag³⁺ ions and a solution of Cu²⁺ ions; wherein the oxidant is hydrogen peroxide; wherein the buffer is glacial acetic acid.

In implementation, the assisted modifying layer is made of the alkaline solution or colloid, wherein the alkaline solution or colloid is made of at least one material selected from the group consisting of: potassium hydroxide and ammonia.

In implementation, the assisted modifying layer is made of at least one of the sol-gel containing the at least one metal and the sol-gel containing the oxide of the at least one metal, wherein the at least one metal is at least one of Al, B, Ga and In, wherein the oxide of the at least one metal is at least one of aluminum oxide, boron oxide, gallium oxide and indium oxide.

In implementation, after the Step C, the method further comprises a following step of: polishing a top surface of the laser-processed wafer.

In implementation, in the Step C, at least one portion of the wafer adjacent to the top surface of the wafer is removed, such that the wafer is at least partially planarized.

In implementation, the at least one portion of the wafer been removed is where the profile distribution of the top surface of the wafer is higher.

In implementation, a portion of the wafer adjacent to the top surface of the wafer is removed, such that the wafer is globally planarized.

In implementation, the laser apparatus is at least one of a diode pumped solid state laser apparatus, a gas laser apparatus, a semiconductor laser apparatus and a fiber laser apparatus.

In implementation, the wafer is made of at least one material selected from the group consisting of: SiC, Ga₂O₃, sapphire, InP, GaAs, diamond, GaN, GaP, quartz, Si, AlN, InAs, SiGe, germanium and ceramic.

In implementation, the scanning device is one of a line scanner, a plane scanner, a height sensor, a distance sensor and a 3D scanner.

For further understanding the characteristics and effects of the present invention, some preferred embodiments referred to drawings are in detail described as follows.

### BRIEF DESCRIPTION OF DRAWINGS

FIG. 1 is a perspective schematic view of an embodiment of a laser processing system for wafer surface of the present invention.

FIG. 2 is a cross-sectional schematic view of the laser processing system for wafer surface in FIG. 1 in a profile scanning state.

FIG. 3 is a schematic view of an embodiment of a scanning path when the laser processing system for wafer surface in FIG. 1 performing profile scanning.

FIG. 4 is a schematic view of another embodiment of a scanning path when the laser processing system for wafer surface in FIG. 1 performing profile scanning.

FIG. 5 is a cross-sectional schematic view of the laser processing system for wafer surface in FIG. 1 in a laser processing state.

FIG. 6A is a schematic view of an embodiment of a laser pulse integration distribution when the laser processing system for wafer surface in FIG. 1 performing laser processing.

FIG. 6B is a cross-sectional schematic view of the profile distribution of the top surface of the wafer along the A-A′ section line in FIG. 6A, wherein the profile distribution of the top surface of the wafer is obtained after scanning by a scanning device before laser processing is performed on the wafer in FIG. 6A.

FIG. 7A is a schematic view of another embodiment of a laser pulse integration distribution when the laser processing system for wafer surface in FIG. 1 performing laser processing.

FIG. 7B is a cross-sectional schematic view of the profile distribution of the top surface of the wafer along the B-B′ section line in FIG. 7A, wherein the profile distribution of the top surface of the wafer is obtained after scanning by a scanning device before laser processing is performed on the wafer in FIG. 7A.

FIG. 8A is a schematic view of another embodiment of a laser pulse integration distribution when the laser processing system for wafer surface in FIG. 1 performing laser processing.

FIG. 8B is a cross-sectional schematic view of the profile distribution of the top surface of the wafer along the C-C′ section line in FIG. 8A, wherein the profile distribution of the top surface of the wafer is obtained after scanning by a scanning device before laser processing is performed on the wafer in FIG. 8A.

FIG. 9A is a schematic view of another embodiment of a laser pulse integration distribution when the laser processing system for wafer surface in FIG. 1 performing laser processing.

FIG. 9B is a cross-sectional schematic view of the profile distribution of the top surface of the wafer along the D-D′ section line in FIG. 9A, wherein the profile distribution of the top surface of the wafer is obtained after scanning by a scanning device before laser processing is performed on the wafer in FIG. 9A.

FIGS. 10A-10C show schematic views of another embodiment of a scanning path when the laser processing system for wafer surface in FIG. 1 performing profile scanning.

FIG. 11 is a schematic view of another embodiment of a scanning path when the laser processing system for wafer surface in FIG. 1 performing profile scanning.

FIGS. 12A-12B show schematic views of another embodiment of a laser pulse integration distribution when the laser processing system for wafer surface in FIG. 1 performing laser processing.

FIG. 13 is a cross-sectional schematic view of another embodiment of a laser processing system for wafer surface of the present invention.

FIG. 14 is a perspective schematic view of a coating device of a laser processing system for wafer surface of the present invention.

FIG. 15A is a schematic view of another embodiment of a laser pulse integration distribution when the laser processing system for wafer surface in FIG. 1 performing laser processing.

FIG. 15B is a cross-sectional schematic view of the profile distribution of the top surface of the wafer along the E-E′ section line in FIG. 15A, wherein the profile distribution of the top surface of the wafer is obtained after scanning by a scanning device before laser processing is performed on the wafer in FIG. 15A.

FIG. 16A is a cross-sectional schematic view of the profile distribution of the top surface of the SiC wafer which has not yet been lapped, wherein the profile distribution is obtained after scanning the top surface of the SiC wafer by the method for laser processing wafer surface of the present invention.

FIG. 16B is a cross-sectional schematic view of the SiC wafer after the SiC wafer in FIG. 16A is laser processed by the method for laser processing wafer surface of the present invention.

FIG. 16C is a cross-sectional schematic view of the SiC wafer after the SiC wafer in FIG. 16A is laser processed to be partially planarized by the method for laser processing wafer surface of the present invention.

FIG. 16D is a cross-sectional schematic view of the SiC wafer after the SiC wafer in FIG. 16A is laser processed to be globally planarized by the method for laser processing wafer surface of the present invention.

FIG. 17 is a schematic view of another embodiment of a laser pulse integration distribution when the laser processing system for wafer surface in FIG. 1 performing laser processing.

FIG. 18A is a cross-sectional schematic view of the profile distribution of the top surface of the SiC wafer which has not yet been lapped in conventional technology.

FIG. 18B is a cross-sectional schematic view of the SiC wafer after being a shallower degree of laser modification on the top surface of the SiC wafer in FIG. 18A.

FIG. 18C is a cross-sectional schematic view of the SiC wafer after the top surface of the SiC wafer in FIG. 18B further being a short period of lapping process (not the complete lapping process).

FIG. 18D is a cross-sectional schematic view of the SiC wafer after being a deeper degree of laser modification on the top surface of the SiC wafer in FIG. 18A.

FIG. 18E is a cross-sectional schematic view of the SiC wafer after the top surface of the SiC wafer in FIG. 18D further being a short period of lapping process (not the complete lapping process).

### DETAILED DESCRIPTIONS OF PREFERRED EMBODIMENTS

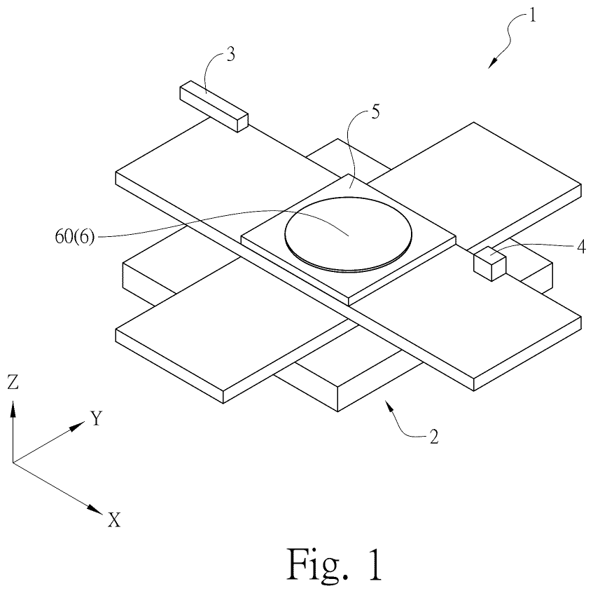

Please refer to FIG. 1, which is a perspective schematic view of an embodiment of a laser processing system for wafer surface of the present invention. The laser processing system 1 for wafer surface of the present invention comprises a motion driving apparatus 2, a scanning device 3, a laser apparatus 4 and a carrying device 5. The carrying device 5 is disposed on the motion driving apparatus 2. The carrying device 5 is used for carrying a wafer 6. The wafer 6 is made of at least one material selected from the group consisting of: SiC, Ga₂O₃, sapphire, InP, GaAs, diamond, GaN, GaP, quartz, Si, AlN, InAs, SiGe, germanium and ceramic. In current embodiment, the motion driving apparatus 2 is a three-axis (including an X-axis positioning stage, a Y-axis positioning stage and a Z-axis positioning stage) positioning stage, wherein the directions of an X-axis, a Y-axis and a Z-axis are shown in FIG. 1. The wafer 6 carried by the carrying device 5 can be moved along any direction of the X-axis direction, the Y-axis direction and the Z-axis direction by the motion driving apparatus 2. Hence, the motion driving apparatus 2 enables a relative displacement between the scanning device 3 and the wafer 6 carried by the carrying device 5 along any direction of the X-axis direction, the Y-axis direction and the Z-axis direction; while the motion driving apparatus 2 also enables a relative displacement between the laser apparatus 4 and the wafer 6 carried by the carrying device 5 along any direction of the X-axis, the Y-axis and the Z-axis. The scanning device 3 is one of a line scanner, a plane scanner, a height sensor, a distance sensor and a 3D scanner. The motion driving apparatus 2 enables the relative displacement between the wafer 6 and the scanning device 3 along the X-axis direction, the Y-axis direction and/or the Z-axis direction, so that the scanning device 3 can scan a top surface 60 of the wafer 6 along a scanning path to obtain a profile distribution of the top surface 60 of the wafer 6. The profile distribution of the top surface 60 of the wafer 6 is a distribution that indicates where is higher or lower on the top surface 60 of the wafer 6. The laser apparatus 4 is at least one of a diode pumped solid state laser apparatus, a gas laser apparatus, a semiconductor laser apparatus and a fiber laser apparatus. The motion driving apparatus 2 enables the relative displacement between the wafer 6 and the laser apparatus 4 along the X-axis direction, the Y-axis direction and/or the Z-axis direction, so that the laser apparatus 4 can perform laser processing on the wafer 6 from the top surface 60 of the wafer 6 with a fluence integration distribution to form a laser-processed wafer, wherein the fluence integration distribution of laser processing performed by the laser apparatus 4 is related to the profile distribution of the top surface 60 of the wafer 6. Moreover, the present invention further provides a method for laser processing wafer surface, which comprises following steps of: Step A: providing a wafer 6 on a carrying device 5 which is disposed on a motion driving apparatus 2, such that the wafer 6 is carried by the carrying device 5; Step B: performing profile scanning a top surface 60 of the wafer 6 by a scanning device 3 to obtain a profile distribution of the top surface 60 of the wafer 6; and Step C: performing laser processing on the wafer 6 from the top surface 60 of the wafer 6 by a laser apparatus 4 with a fluence integration distribution to form a laser-processed wafer, wherein the fluence integration distribution of laser processing performed by the laser apparatus 4 is related to the profile distribution of the top surface 60 of the wafer 6. According to different situations and different needs, the method for laser processing wafer surface of the present invention can select one condition among various conditions such that the fluence integration distribution of laser processing performed by the laser apparatus 4 and the profile distribution of the top surface 60 of the wafer 6 meet that one condition. The condition that the fluence integration distribution of laser processing performed by the laser apparatus 4 and the profile distribution of the top surface 60 of the wafer 6 met can be chosen from at least the following six conditions: (1) the first condition: where the profile distribution of the top surface 60 of the wafer 6 is higher, the fluence integration distribution of laser processing performed by the laser apparatus 4 is approximately higher; (2) the second condition: the profile distribution of the top surface 60 of the wafer 6 has a maximum value and a minimum value, a difference of the maximum value and the minimum value of the profile distribution of the top surface 60 of the wafer 6 is defined as a high-low range of the profile distribution of the top surface 60 of the wafer 6, a difference of the profile distribution of the top surface 60 of the wafer 6 and the minimum value of the profile distribution of the top surface 60 of the wafer 6 is defined as a normalized profile distribution of the top surface 60 of the wafer 6, a ratio of the normalized profile distribution of the top surface 60 of the wafer 6 to the high-low range of the profile distribution of the top surface 60 of the wafer 6 is defined as a normalized-profile proportion distribution of the top surface 60 of the wafer 6, wherein the fluence integration distribution of laser processing performed by the laser apparatus 4 is approximately proportional to the normalized-profile proportion distribution of the top surface 60 of the wafer 6; (3) the third condition: where the profile distribution of the top surface 60 of the wafer 6 is smaller than or equal to a minimum height threshold, the fluence integration distribution of laser processing performed by the laser apparatus 4 is approximately equal to a minimum fluence integration threshold, wherein the minimum fluence integration threshold is greater than or equal to zero; (4) the fourth condition: where the profile distribution of the top surface 60 of the wafer 6 is smaller than or equal to a minimum height threshold, the fluence integration distribution of laser processing performed by the laser apparatus 4 is approximately equal to a minimum fluence integration threshold, wherein the minimum fluence integration threshold is greater than or equal to zero; while the profile distribution of the top surface 60 of the wafer 6 is greater than the minimum height threshold, where the profile distribution of the top surface 60 of the wafer 6 is higher, the fluence integration distribution of laser processing performed by the laser apparatus 4 is approximately higher; (5) the fifth condition: where the profile distribution of the top surface 60 of the wafer 6 is higher, the fluence integration distribution of laser processing performed by the laser apparatus 4 is approximately lower; and (6) the sixth condition: the profile distribution of the top surface 60 of the wafer 6 has a maximum value and a minimum value, a difference of the maximum value and the minimum value of the profile distribution of the top surface 60 of the wafer 6 is defined as a high-low range of the profile distribution of the top surface 60 of the wafer 6, a difference of the profile distribution of the top surface 60 of the wafer 6 and the minimum value of the profile distribution of the top surface 60 of the wafer 6 is defined as a normalized profile distribution of the top surface 60 of the wafer 6, a ratio of the normalized profile distribution of the top surface 60 of the wafer 6 to the high-low range of the profile distribution of the top surface 60 of the wafer 6 is defined as a normalized-profile proportion distribution of the top surface 60 of the wafer 6, wherein the fluence integration distribution of laser processing performed by the laser apparatus 4 is approximately inversely proportional to the normalized-profile proportion distribution of the top surface 60 of the wafer 6.

In the Step C of the method for laser processing wafer surface of the present invention, the laser apparatus 4 performs laser processing on the wafer 6 from the top surface 60 of the wafer 6 with the fluence integration distribution to form a laser-processed wafer, wherein the condition that the fluence integration distribution of laser processing performed by the laser apparatus 4 and the profile distribution of the top surface 60 of the wafer 6 met is not limited to one of the above six conditions. The requirement for the conditions is: the fluence integration distribution of laser processing performed by the laser apparatus 4 is related to the profile distribution of the top surface 60 of the wafer 6 (that is, the fluence integration distribution of laser processing performed by the laser apparatus 4 is according to the profile distribution of the top surface 60 of the wafer 6).

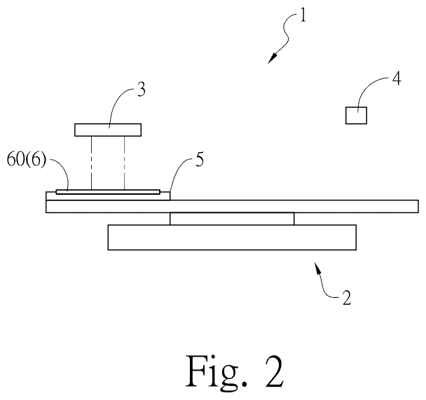

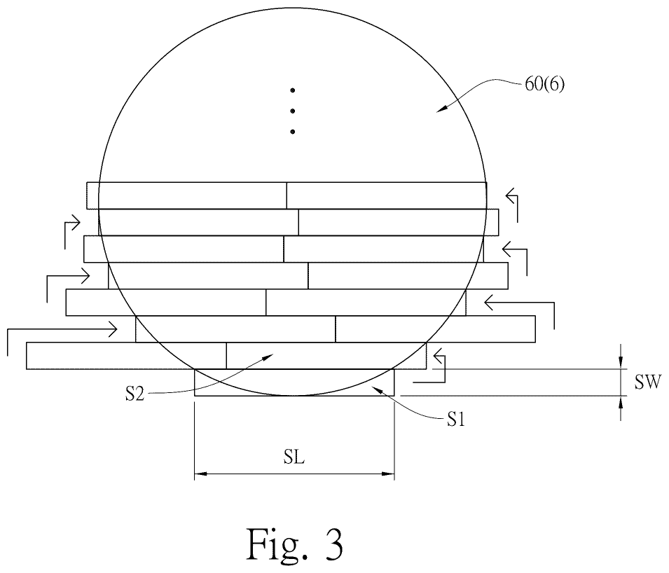

Please refer to FIG. 2, which is a cross-sectional schematic view of the laser processing system for wafer surface in FIG. 1 in a profile scanning state. In current embodiment, the scanning device 3 is a line scanner. The motion driving apparatus 2 moves the wafer 6 carried by the carrying device 5 along the X-axis direction and/or the Y-axis direction, such that the wafer 6 is moved below the scanning device 3. Then the motion driving apparatus 2 moves the wafer 6 carried by the carrying device 5 along the Z-axis direction, such that the wafer 6 is moved to a height required for scanning by the scanning device 3. And then the motion driving apparatus 2 moves the wafer 6 carried by the carrying device 5 along the X-axis direction and/or the Y-axis direction, so that the scanning device 3 can perform profile scanning the top surface 60 of the wafer 6 along a scanning path to obtain a profile distribution of the top surface 60 of the wafer 6. Please also refer to FIG. 3, which is a schematic view of an embodiment of a scanning path when the laser processing system for wafer surface in FIG. 1 performing profile scanning. In current embodiment, each time the scanning device 3 (line scanner) performs a single profile scanning, a scanning range of the scanning device 3 (line scanner) is a rectangle (a scanning length SL×a scanning width SW, wherein usually a scanning length SL of a line scanner is much greater than a scanning width SW of that line scanner). The scanning path in FIG. 3 is suitable for the scanning length SL of the scanning device 3 (line scanner) smaller than a diameter of the wafer 6. A plurality of identical rectangles is shown in FIG. 3. Each of the rectangles has a length equal to the scanning length SL of the scanning device 3 (line scanner). Each of the rectangles has a width equal to the scanning width SW of the scanning device 3 (line scanner). The motion driving apparatus 2 moves the wafer 6 carried by the carrying device 5 along the Z-axis direction, such that the wafer 6 is moved to a height required for scanning by the scanning device 3. Then the motion driving apparatus 2 moves the wafer 6 carried by the carrying device 5 along the X-axis direction and/or the Y-axis direction, so that a geometric center of a first rectangle S1 is located directly below a scanning center of the scanning device 3 (line scanner), and such that the scanning range of the scanning device 3 (line scanner) is coincident with the first rectangle S1, and then the scanning device 3 performs a first profile scanning (a single profile scanning). Then the motion driving apparatus 2 moves the wafer 6 carried by the carrying device 5 along the X-axis direction and/or the Y-axis direction, so that a geometric center of a second rectangle S2 is located directly below the scanning center of the scanning device 3 (line scanner), and such that the scanning range of the scanning device 3 (line scanner) is coincident with the second rectangle S2, and then the scanning device 3 performs a second profile scanning (a single profile scanning). And so on, sequentially moving the wafer 6 carried by the carrying device 5 so that the scanning range of the scanning device 3 (line scanner) is coincident with each of the rectangles one by one, and then the scanning device 3 performs a single profile scanning one by one. After the scanning device 3 completely scanning the top surface 60 of the wafer 6, the scanned results are integrated into a profile distribution of the top surface 60 of the wafer 6.

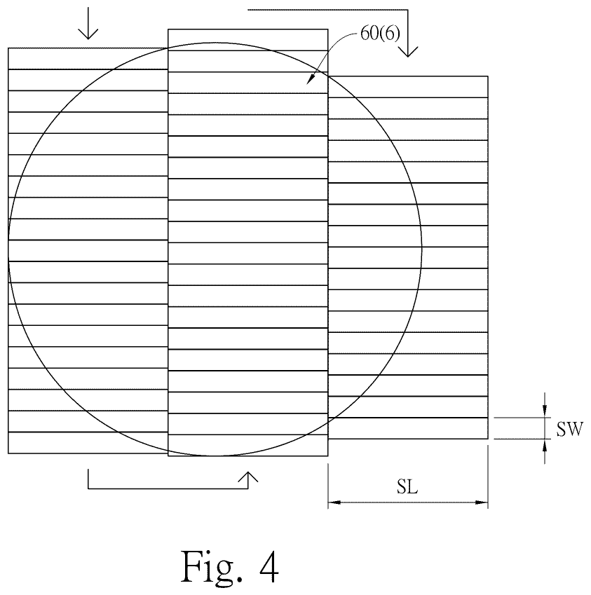

Please refer to FIG. 4, which is a schematic view of another embodiment of a scanning path when the laser processing system for wafer surface in FIG. 1 performing profile scanning. The scanning path in FIG. 4 is also suitable for the scanning length SL of the scanning device 3 (line scanner) smaller than the diameter of the wafer 6. As shown by the arrow in FIG. 4, the scanning path starts from the upper left corner to the lower left corner, sequentially moving the scanning range of the scanning device 3 to be coincident with each of the rectangles one by one, and then the scanning device 3 performs a single profile scanning one by one. And then the scanning path starts from the lower middle to the upper middle, sequentially moving the scanning range of the scanning device 3 to be coincident with each of the rectangles one by one, and then the scanning device 3 performs a single profile scanning one by one. And then the scanning path starts from the upper right corner to the lower right corner, sequentially moving the scanning range of the scanning device 3 to be coincident with each of the rectangles one by one, and then the scanning device 3 performs a single profile scanning one by one. After the scanning device 3 completely scanning the top surface 60 of the wafer 6, the scanned results are integrated into a profile distribution of the top surface 60 of the wafer 6.

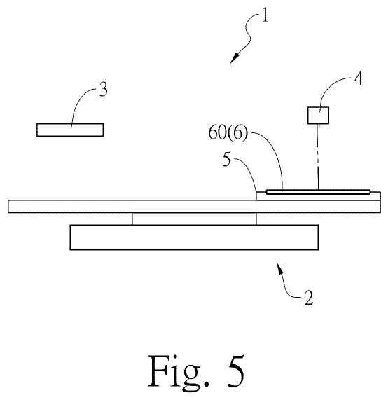

Please refer to FIG. 5, which is a cross-sectional schematic view of the laser processing system for wafer surface in FIG. 1 in a laser processing state. The profile distribution of the top surface 60 of the wafer 6 is obtained after the scanning device 3 completely scanning the top surface 60 of the wafer 6. Then the motion driving apparatus 2 moves the wafer 6 carried by the carrying device 5 along the X-axis direction, the Y-axis direction and the Z-axis direction, such that the wafer 6 is moved below the laser apparatus 4 and moved to a height required for laser processing by the laser apparatus 4. And then the laser apparatus 4 performs laser processing on the wafer 6 from the top surface 60 of the wafer 6 with a fluence integration distribution to form a laser-processed wafer. The fluence integration distribution of laser processing performed by the laser apparatus 4 is according to the profile distribution of the top surface 60 of the wafer 6; that is, the fluence integration distribution of laser processing performed by the laser apparatus 4 is related to the profile distribution of the top surface 60 of the wafer 6. According to different situations and different needs, the condition that the fluence integration distribution of laser processing performed by the laser apparatus 4 and the profile distribution of the top surface 60 of the wafer 6 met can be chosen from at least the six conditions mentioned above. Laser processing performed on the wafer 6 with the fluence integration distribution by the laser apparatus 4 is from the top surface 60 of the wafer 6. Laser processing can be controlled by many parameters to achieve laser processing with the fluence integration distribution. One of the parameters is a fluence F of the laser apparatus 4. The fluence F of the laser apparatus 4 is defined as:

$$F = \frac{P}{Af} , \qquad ( Equation 1 )$$

wherein P is a power of the laser apparatus 4; A is a spot area of a single laser pulse generated by the laser apparatus 4 on a focal plane of the single laser pulse; f (unit Hz) is a pulse repetition rate of the laser apparatus 4. The fluence F of the laser apparatus 4 can be controlled by controlling the power P of the laser apparatus 4, the spot area A of the single laser pulse generated by the laser apparatus 4 on the focal plane of the single laser pulse, and the pulse repetition rate of the laser apparatus 4. The unit of the fluence F of the laser apparatus 4 can be, for example, J/cm². After laser processing on the wafer 6 from the top surface 60 of the wafer 6 with a fluence integration distribution by the laser apparatus 4, the fluence integration distribution of laser processing performed by the laser apparatus 4 is defined as: a laser pulse integration distribution of the laser pulses processing on the wafer 6 from the top surface 60 of the wafer 6×a fluence F of the laser apparatus 4. That is,

$$the fluence integration distribution = the laser pulse integration distribution \times the fluence F .$$

When performing laser processing, the fluence F of the laser apparatus 4 must be greater than or equal to a minimum fluence threshold, so that laser processing on the wafer 6 from the top surface 60 of the wafer 6 by the laser apparatus 4 is effective, and such that the region of the wafer 6 that has been laser processed by the laser apparatus 4 is modified and the hardness of that region becomes softer. When the fluence F of the laser apparatus 4 is smaller than the minimum fluence threshold, the laser apparatus 4 cannot perform effective laser processed on the wafer 6 (that is, the region of the wafer 6 that has been laser processed by the laser apparatus 4 cannot be modified). The minimum fluence threshold is not only related to the power P of the laser apparatus 4, the spot area A of the single laser pulse generated by the laser apparatus 4 on the focal plane of the single laser pulse and the pulse repetition rate of the laser apparatus 4, but the minimum fluence threshold is also affected by a wavelength of the laser apparatus 4 and a material that the wafer 6 is made of.

In some embodiments, after the Step C, the method for laser processing wafer surface of the present invention further comprises a following step of: polishing a top surface of the laser-processed wafer, wherein the laser-processed wafer is formed after the wafer 6 has been laser processed in the Step C.

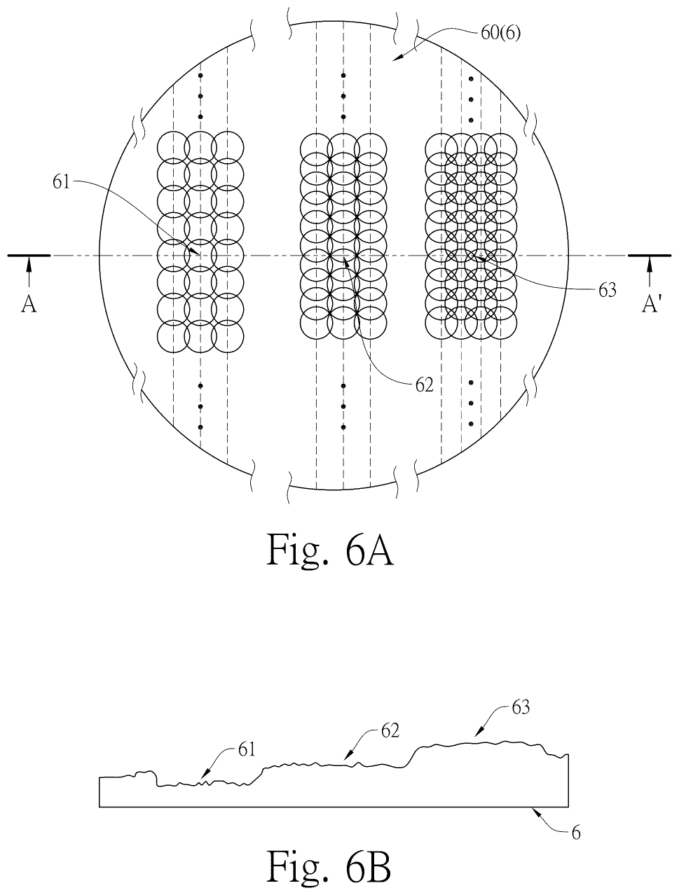

Please refer to FIG. 6A, which is a schematic view of an embodiment of a laser pulse integration distribution when the laser processing system for wafer surface in FIG. 1 performing laser processing. Please also refer to FIG. 6B, which is a cross-sectional schematic view of the profile distribution of the top surface of the wafer along the A-A′ section line in FIG. 6A, wherein the profile distribution of the top surface of the wafer is obtained after scanning by a scanning device before laser processing is performed on the wafer in FIG. 6A. In current embodiment, the method for laser processing wafer surface of the present invention comprises following steps of: Step A: providing a wafer 6 on a carrying device 5 which is disposed on a motion driving apparatus 2, such that the wafer 6 is carried by the carrying device 5; Step B: performing profile scanning a top surface 60 of the wafer 6 by a scanning device 3 to obtain a profile distribution of the top surface 60 of the wafer 6 (the top surface 60 of the wafer 6 can be completely scanned by the scanning device 3 to obtain the complete profile distribution of the top surface 60 of the wafer 6; wherein FIG. 6B only shows a cross-sectional schematic view of the profile distribution of the top surface 60 of the wafer 6 along the A-A′ section line in FIG. 6A); and Step C: performing laser processing on the wafer 6 from the top surface 60 of the wafer 6 by a laser apparatus 4 with a fluence integration distribution to form a laser-processed wafer, according to the profile distribution of the top surface 60 of the wafer 6. In current embodiment, the first condition of the six conditions mentioned above is selected as the condition that the fluence integration distribution of laser processing performed by the laser apparatus 4 and the profile distribution of the top surface 60 of the wafer 6 met, wherein the first condition is as the following: where the profile distribution of the top surface 60 of the wafer 6 is higher, the fluence integration distribution of laser processing performed by the laser apparatus 4 is approximately higher. FIGS. 6A and 6B show that the top surface 60 of the wafer 6 includes a region 61, a region 62 and a region 63. FIG. 6B shows that the profile distribution of the region 61 is roughly smaller than the profile distribution of the region 62; the profile distribution of the region 62 is roughly smaller than the profile distribution of the region 63. In current embodiment, when performing laser processing, the fluence F of the laser apparatus 4 is controlled to be a constant value. Since

$$the fluence integration distribution = the laser pulse integration distribution \times the fluence F ;$$

hence, when the fluence F of the laser apparatus 4 is controlled to be a constant value, the fluence integration distribution of laser processing performed by the laser apparatus 4 in the region 61 can be controlled to be smaller than the fluence integration distribution of laser processing performed by the laser apparatus 4 in the region 62 and the fluence integration distribution of laser processing performed by the laser apparatus 4 in the region 62 can be controlled to be smaller than the fluence integration distribution of laser processing performed by the laser apparatus 4 in the region 63 by controlling the laser pulse integration distribution of laser processing performed by the laser apparatus 4 in the region 61 to be smaller than the laser pulse integration distribution of laser processing performed by the laser apparatus 4 in the region 62 and the laser pulse integration distribution of laser processing performed by the laser apparatus 4 in the region 62 to be smaller than the laser pulse integration distribution of laser processing performed by the laser apparatus 4 in the region 63. Therefore, it can be achieved that when performing laser processing by the laser apparatus 4, it is based on that where the profile distribution of the top surface 60 of the wafer 6 is higher, the fluence integration distribution of laser processing performed by the laser apparatus 4 is approximately higher. In FIG. 6A, each circle represents a single laser pulse generated by the laser apparatus 4 processing on the wafer 6 from the top surface 60 of the wafer 6, wherein the fluence F of the laser apparatus 4 is controlled to be a constant value. In the region 61, there are three laser processing paths of the laser apparatus 4. The three laser processing paths of the laser apparatus 4 are respectively along the three dotted lines in the region 61 either from the top to the bottom or from the bottom to the top. The laser pulses generated by the laser apparatus 4 along each of the laser processing paths (along each of the three dotted lines in the region 61) have an overlapping rate along a laser processing path direction of the laser processing path. The laser pulses generated by the laser apparatus 4 along any two adjacent laser processing paths (along any two adjacent dotted lines in the region 61) have an overlapping rate along a separation direction of the two adjacent laser processing paths; that is, the laser pulses along the laser processing path of the left dotted line in the region 61 and the laser pulses along the laser processing path of the middle dotted line in the region 61 have an overlapping rate along a separation direction of the two adjacent laser processing paths (the left dotted line and the middle dotted line in the region 61); and the laser pulses along the laser processing path of the middle dotted line in the region 61 and the laser pulses along the laser processing path of the right dotted line in the region 61 have an overlapping rate along a separation direction of the two adjacent laser processing paths (the middle dotted line and the right dotted line in the region 61). In the region 62, there are three laser processing paths of the laser apparatus 4. The three laser processing paths of the laser apparatus 4 are respectively along the three dotted lines in the region 62 either from the top to the bottom or from the bottom to the top. The laser pulses generated by the laser apparatus 4 along each of the laser processing paths (along each of the three dotted lines in the region 62) have an overlapping rate along a laser processing path direction of the laser processing path. The laser pulses generated by the laser apparatus 4 along any two adjacent laser processing paths (along any two adjacent dotted lines in the region 62) have an overlapping rate along a separation direction of the two adjacent laser processing paths; that is, the laser pulses along the laser processing path of the left dotted line in the region 62 and the laser pulses along the laser processing path of the middle dotted line in the region 62 have an overlapping rate along a separation direction of the two adjacent laser processing paths (the left dotted line and the middle dotted line in the region 62); and the laser pulses along the laser processing path of the middle dotted line in the region 62 and the laser pulses along the laser processing path of the right dotted line in the region 62 have an overlapping rate along a separation direction of the two adjacent laser processing paths (the middle dotted line and the right dotted line in the region 62). In the region 63, there are four laser processing paths of the laser apparatus 4. The four laser processing paths of the laser apparatus 4 are respectively along the four dotted lines in the region 63 either from the top to the bottom or from the bottom to the top. The laser pulses generated by the laser apparatus 4 along each of the laser processing paths (along each of the four dotted lines in the region 63) have an overlapping rate along a laser processing path direction of the laser processing path. The laser pulses generated by the laser apparatus 4 along any two adjacent laser processing paths (along any two adjacent dotted lines in the region 63) have an overlapping rate along a separation direction of the two adjacent laser processing paths; that is, the laser pulses along the laser processing path of the first dotted line on the left in the region 63 and the laser pulses along the laser processing path of the second dotted line on the left in the region 63 have an overlapping rate along a separation direction of the two adjacent laser processing paths (the first dotted line on the left and the second dotted line on the left in the region 63); the laser pulses along the laser processing path of the second dotted line on the left in the region 63 and the laser pulses along the laser processing path of the second dotted line on the right in the region 63 have an overlapping rate along a separation direction of the two adjacent laser processing paths (the second dotted line on the left and the second dotted line on the right in the region 63); the laser pulses along the laser processing path of the second dotted line on the right in the region 63 and the laser pulses along the laser processing path of the first dotted line on the right in the region 63 have an overlapping rate along a separation direction of the two adjacent laser processing paths (the second dotted line on the right and the first dotted line on the right in the region 63). The overlapping rate of the laser pulses along the laser processing path direction of the laser processing path in the region 61 is smaller than the overlapping rate of the laser pulses along the laser processing path direction of the laser processing path in the region 62, and the overlapping rate of the laser pulses along the separation direction of two adjacent laser processing paths in the region 61 is equal to the overlapping rate of the laser pulses along the separation direction of two adjacent laser processing paths in the region 62; while the overlapping rate of the laser pulses along the laser processing path direction of the laser processing path in the region 62 is equal to the overlapping rate of the laser pulses along the laser processing path direction of the laser processing path in the region 63, and the overlapping rate of the laser pulses along the separation direction of two adjacent laser processing paths in the region 62 is smaller than the overlapping rate of the laser pulses along the separation direction of two adjacent laser processing paths in the region 63. That is, the laser pulse integration distribution of the laser pulses in the region 61 is smaller than the laser pulse integration distribution of the laser pulses in the region 62, and the laser pulse integration distribution of the laser pulses in the region 62 is smaller than the laser pulse integration distribution of the laser pulses in the region 63. Therefore, in current embodiment, the method for laser processing wafer surface of the present invention controls the overlapping rate of the laser pulses along the laser processing path direction of the laser processing path and the overlapping rate of the laser pulses along the separation direction of two adjacent laser processing paths, so that the laser pulse integration distribution of the laser pulses generated by the laser apparatus 4 processing on the wafer 6 from the top surface 60 of the wafer 6 can be controlled (so that the laser pulse integration distribution in the region 61 can be controlled to be smaller than the laser pulse integration distribution in the region 62, and the laser pulse integration distribution in the region 62 can be controlled to be smaller than the laser pulse integration distribution in the region 63). Since the fluence F of the laser apparatus 4 is controlled to be a constant value (when the fluence F of the laser apparatus 4 is controlled to be a constant value, the fluence integration distribution is proportional to the laser pulse integration distribution); hence, the fluence integration distribution in the region 61 is capable of being controlled to be smaller than the fluence integration distribution in the region 62, and the fluence integration distribution in the region 62 is capable of being controlled to be smaller than the fluence integration distribution in the region 63). Therefore, it can be achieved that when performing laser processing by the laser apparatus 4, it is based on that where the profile distribution of the top surface 60 of the wafer 6 is higher, the fluence integration distribution of laser processing performed by the laser apparatus 4 is approximately higher.

In some embodiments, the fluence F of the laser apparatus 4 can be controlled to be a constant value or a variable value. The method for laser processing wafer surface of the present invention controls a fluence F of the laser apparatus 4 by controlling a power P of the laser apparatus 4, a spot area A of a single laser pulse generated by the laser apparatus 4 on a focal plane of the single laser pulse, and a pulse repetition rate f of the laser apparatus 4; and controls a laser pulse integration distribution of the laser pulses generated by the laser apparatus 4 processing on the wafer 6 from the top surface 60 of the wafer 6 by controlling an overlapping rate of the laser pulses along a laser processing path direction of a laser processing path and an overlapping rate of the laser pulses along a separation direction of two adjacent laser processing paths; and controls the fluence integration distribution of laser processing performed by the laser apparatus 4 by controlling the laser pulse integration distribution and the fluence F of the laser apparatus 4.

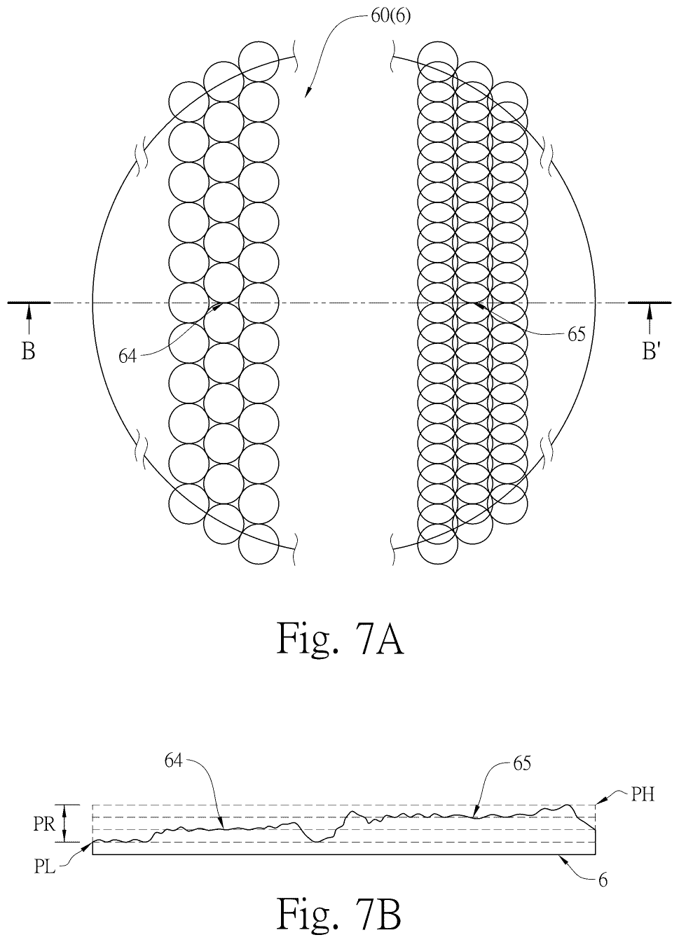

Please refer to FIG. 7A, which is a schematic view of another embodiment of a laser pulse integration distribution when the laser processing system for wafer surface in FIG. 1 performing laser processing. Please also refer to FIG. 7B, which is a cross-sectional schematic view of the profile distribution of the top surface of the wafer along the B-B′ section line in FIG. 7A, wherein the profile distribution of the top surface of the wafer is obtained after scanning by a scanning device before laser processing is performed on the wafer in FIG. 7A. In current embodiment, in the Step B of the method for laser processing wafer surface of the present invention, the top surface 60 of the wafer 6 can be completely scanned by the scanning device 3 to obtain the complete profile distribution of the top surface 60 of the wafer 6; wherein FIG. 7B only shows a cross-sectional schematic view of the profile distribution of the top surface 60 of the wafer 6 along the B-B′ section line in FIG. 7A. In the Step C, laser processing is performed on the wafer 6 from the top surface 60 of the wafer 6 by a laser apparatus 4 with a fluence integration distribution to form a laser-processed wafer, according to the profile distribution of the top surface 60 of the wafer 6. In current embodiment, the second condition of the six conditions mentioned above is selected as the condition that the fluence integration distribution of laser processing performed by the laser apparatus 4 and the profile distribution of the top surface 60 of the wafer 6 met, wherein the second condition is as the following: the profile distribution of the top surface 60 of the wafer 6 has a maximum value and a minimum value, a difference of the maximum value and the minimum value of the profile distribution of the top surface 60 of the wafer 6 is defined as a high-low range of the profile distribution of the top surface 60 of the wafer 6, a difference of the profile distribution of the top surface 60 of the wafer 6 and the minimum value of the profile distribution of the top surface 60 of the wafer 6 is defined as a normalized profile distribution of the top surface 60 of the wafer 6, a ratio of the normalized profile distribution of the top surface 60 of the wafer 6 to the high-low range of the profile distribution of the top surface 60 of the wafer 6 is defined as a normalized-profile proportion distribution of the top surface 60 of the wafer 6, wherein the fluence integration distribution of laser processing performed by the laser apparatus 4 is approximately proportional to the normalized-profile proportion distribution of the top surface 60 of the wafer 6. FIGS. 7A and 7B show that the top surface 60 of the wafer 6 includes a region 64 and a region 65. FIG. 7B shows that the profile distribution of the top surface 60 of the wafer 6 has a maximum value PH and a minimum value PL. A difference of the maximum value PH and the minimum value PL is a high-low range PR of the profile distribution of the top surface 60 of the wafer 6. A difference of the profile distribution of the top surface 60 of the wafer 6 and the minimum value PL is defined as a normalized profile distribution of the top surface 60 of the wafer 6. A ratio of the normalized profile distribution of the top surface 60 of the wafer 6 to the high-low range PR of the profile distribution of the top surface 60 of the wafer 6 is defined as a normalized-profile proportion distribution of the top surface 60 of the wafer 6. In the region 64, the difference of the profile distribution of the top surface 60 of the wafer 6 and the minimum value PL is approximately equal to the high-low range PR/3 (i.e. the normalized profile distribution of the top surface 60 of the wafer 6); hence, in the region 64, the ratio of the normalized profile distribution of the top surface 60 of the wafer 6 to the high-low range PR is approximately equal to ⅓ (i.e. the normalized-profile proportion distribution of the top surface 60 of the wafer 6). In the region 65, the difference of the profile distribution of the top surface 60 of the wafer 6 and the minimum value PL is approximately equal to 2×(the high-low range PR)/3 (i.e. the normalized profile distribution of the top surface 60 of the wafer 6); hence, in the region 65, the ratio of the normalized profile distribution of the top surface 60 of the wafer 6 to the high-low range PR is approximately equal to ⅔ (i.e. the normalized-profile proportion distribution of the top surface 60 of the wafer 6). Therefore, the normalized-profile proportion distribution of the top surface 60 of the wafer 6 in the region 65 is approximately twice of the normalized-profile proportion distribution of the top surface 60 of the wafer 6 in the region 64. In current embodiment, when performing laser processing, the fluence F of the laser apparatus 4 is controlled to be a constant value. In FIG. 7A, the laser pulse integration distribution of laser processing performed by the laser apparatus 4 in the region 65 is approximately twice of the laser pulse integration distribution of laser processing performed by the laser apparatus 4 in the region 64. Since

$$the fluence integration distribution = the laser pulse integration distribution \times the fluence F ;$$

hence, in current embodiment, the method for laser processing wafer surface of the present invention controls the overlapping rate of the laser pulses along the laser processing path direction of the laser processing path and the overlapping rate of the laser pulses along the separation direction of two adjacent laser processing paths, so that the laser pulse integration distribution of laser processing performed by the laser apparatus 4 in the region 65 can be controlled to be approximately twice of the laser pulse integration distribution of laser processing performed by the laser apparatus 4 in the region 64. Since the fluence F of the laser apparatus 4 is controlled to be a constant value (when the fluence F of the laser apparatus 4 is controlled to be a constant value, the fluence integration distribution is proportional to the laser pulse integration distribution); hence, the fluence integration distribution of laser processing performed by the laser apparatus 4 in the region 65 can be controlled to be approximately twice of the fluence integration distribution of laser processing performed by the laser apparatus 4 in the region 64. Therefore, it can be achieved that the fluence integration distribution of laser processing performed by the laser apparatus 4 is approximately proportional to the normalized-profile proportion distribution of the top surface 60 of the wafer 6.

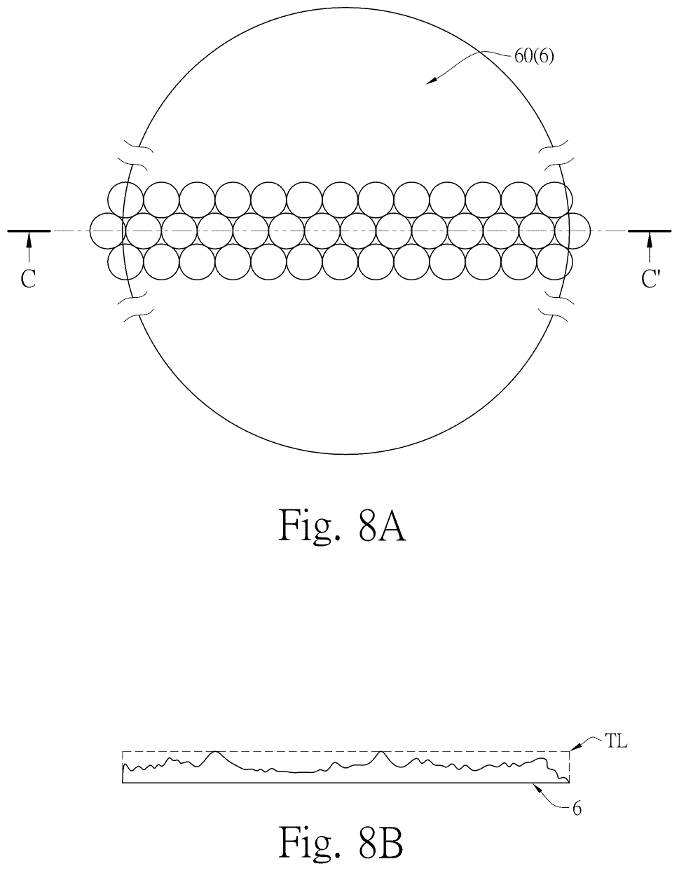

Please refer to FIG. 8A, which is a schematic view of another embodiment of a laser pulse integration distribution when the laser processing system for wafer surface in FIG. 1 performing laser processing. Please also refer to FIG. 8B, which is a cross-sectional schematic view of the profile distribution of the top surface of the wafer along the C-C′ section line in FIG. 8A, wherein the profile distribution of the top surface of the wafer is obtained after scanning by a scanning device before laser processing is performed on the wafer in FIG. 8A. In current embodiment, in the Step B of the method for laser processing wafer surface of the present invention, the top surface 60 of the wafer 6 can be completely scanned by the scanning device 3 to obtain the complete profile distribution of the top surface 60 of the wafer 6; wherein FIG. 8B only shows a cross-sectional schematic view of the profile distribution of the top surface 60 of the wafer 6 along the C-C′ section line in FIG. 8A. In the Step C, laser processing is performed on the wafer 6 from the top surface 60 of the wafer 6 by a laser apparatus 4 with a fluence integration distribution to form a laser-processed wafer, according to the profile distribution of the top surface 60 of the wafer 6. In current embodiment, the third condition of the six conditions mentioned above is selected as the condition that the fluence integration distribution of laser processing performed by the laser apparatus 4 and the profile distribution of the top surface 60 of the wafer 6 met, wherein the third condition is as the following: where the profile distribution of the top surface 60 of the wafer 6 is smaller than or equal to a minimum height threshold, the fluence integration distribution of laser processing performed by the laser apparatus 4 is approximately equal to a minimum fluence integration threshold, wherein the minimum fluence integration threshold is greater than or equal to zero. FIG. 8B shows that the profile distribution of the top surface 60 of the wafer 6 is smaller than or equal to a minimum height threshold TL. In current embodiment, when performing laser processing, the fluence F of the laser apparatus 4 is controlled to be a constant value. In FIG. 8A, the laser pulse integration distribution of laser processing performed by the laser apparatus 4 near the C-C′ section line in FIG. 8A is approximately a constant value. Since

$$the fluence integration distribution = the laser pulse integration distribution \times the fluence F ;$$

hence, in current embodiment, the method for laser processing wafer surface of the present invention controls the overlapping rate of the laser pulses along the laser processing path direction of the laser processing path and the overlapping rate of the laser pulses along the separation direction of two adjacent laser processing paths, so that the laser pulse integration distribution of laser processing performed by the laser apparatus 4 near the C-C′ section line can be controlled to be approximately a constant value, and so that

$$the laser pulse integration distribution ( approximately a constant value ) \times the fluence F ( a constant value ) =$$

the fluence integration distribution (approximately a minimum fluence integration threshold). That is, the fluence integration distribution of laser processing performed by the laser apparatus 4 near the C-C′ section line can be controlled to be approximately equal to a minimum fluence integration threshold by controlling the laser pulse integration distribution of laser processing performed by the laser apparatus 4 near the C-C′ section line to be approximately a constant value and the fluence F of the laser apparatus 4 to be a constant value. Therefore, it can be achieved that where the profile distribution of the top surface 60 of the wafer 6 is smaller than or equal to a minimum height threshold, the fluence integration distribution of laser processing performed by the laser apparatus 4 is approximately equal to a minimum fluence integration threshold (in current embodiment, the minimum fluence integration threshold is greater than zero).

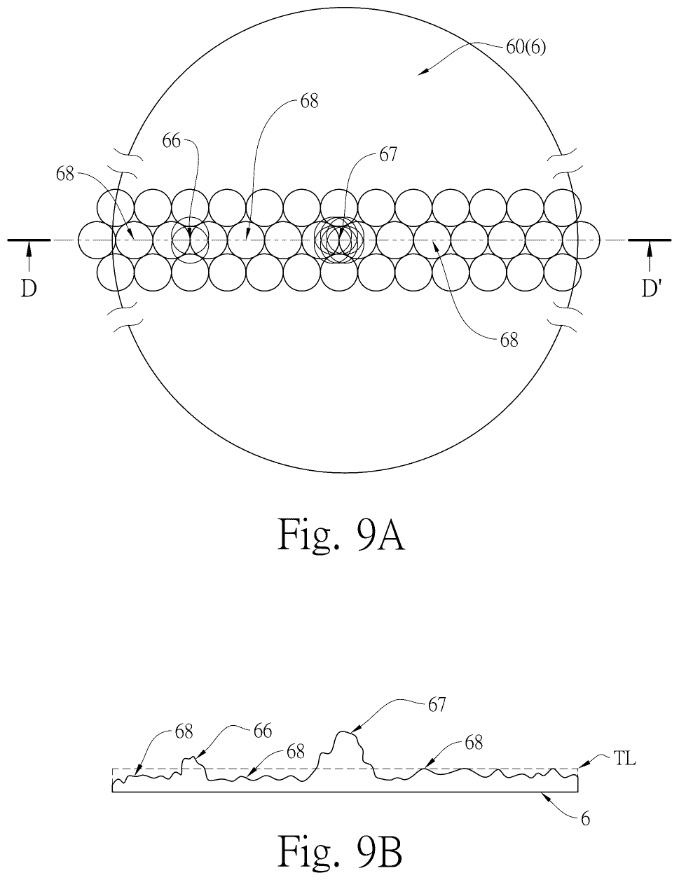

Please refer to FIG. 9A, which is a schematic view of another embodiment of a laser pulse integration distribution when the laser processing system for wafer surface in FIG. 1 performing laser processing. Please also refer to FIG. 9B, which is a cross-sectional schematic view of the profile distribution of the top surface of the wafer along the D-D′ section line in FIG. 9A, wherein the profile distribution of the top surface of the wafer is obtained after scanning by a scanning device before laser processing is performed on the wafer in FIG. 9A. In current embodiment, in the Step B of the method for laser processing wafer surface of the present invention, the top surface 60 of the wafer 6 can be completely scanned by the scanning device 3 to obtain the complete profile distribution of the top surface 60 of the wafer 6; wherein FIG. 9B only shows a cross-sectional schematic view of the profile distribution of the top surface 60 of the wafer 6 along the D-D′ section line in FIG. 9A. In the Step C, laser processing is performed on the wafer 6 from the top surface 60 of the wafer 6 by a laser apparatus 4 with a fluence integration distribution to form a laser-processed wafer, according to the profile distribution of the top surface 60 of the wafer 6. In current embodiment, the fourth condition of the six conditions mentioned above is selected as the condition that the fluence integration distribution of laser processing performed by the laser apparatus 4 and the profile distribution of the top surface 60 of the wafer 6 met, wherein the fourth condition is as the following: where the profile distribution of the top surface 60 of the wafer 6 is smaller than or equal to a minimum height threshold, the fluence integration distribution of laser processing performed by the laser apparatus 4 is approximately equal to a minimum fluence integration threshold, wherein the minimum fluence integration threshold is greater than or equal to zero; while the profile distribution of the top surface 60 of the wafer 6 is greater than the minimum height threshold, where the profile distribution of the top surface 60 of the wafer 6 is higher, the fluence integration distribution of laser processing performed by the laser apparatus 4 is approximately higher. FIGS. 9A and 9B show that the top surface 60 of the wafer 6 includes a region 66, a region 67 and a region 68, wherein the region 68 is the region outside the region 66 and the region 67. FIG. 9B shows that the profile distribution of the region 68 is smaller than or equal to a minimum height threshold TL; the profile distribution of the region 66 is greater than the minimum height threshold TL; while the profile distribution of the region 67 is greater than the profile distribution of the region 66. In current embodiment, when performing laser processing, the fluence F of the laser apparatus 4 is controlled to be a constant value. In FIG. 9A, the laser pulse integration distribution of laser processing performed by the laser apparatus 4 in the region 68 is approximately a constant value. Since

$$the fluence integration distribution = the laser pulse integration distribution \times the fluence F ;$$

hence, in current embodiment, the method for laser processing wafer surface of the present invention controls the overlapping rate of the laser pulses along the laser processing path direction of the laser processing path and the overlapping rate of the laser pulses along the separation direction of two adjacent laser processing paths, so that the laser pulse integration distribution of laser processing performed by the laser apparatus 4 in the region 68 can be controlled to be approximately a constant value, and so that

$$the laser pulse integration distribution ( approximately a constant value ) \times the fluence F ( a constant value ) =$$

the fluence integration distribution (approximately a minimum fluence integration threshold). That is, the fluence integration distribution of laser processing performed by the laser apparatus 4 in the region 68 can be controlled to be approximately equal to a minimum fluence integration threshold by controlling the laser pulse integration distribution of laser processing performed by the laser apparatus 4 in the region 68 to be approximately a constant value and the fluence F of the laser apparatus 4 to be a constant value. Therefore, it can be achieved that where the profile distribution of the top surface 60 of the wafer 6 is smaller than or equal to a minimum height threshold, the fluence integration distribution of laser processing performed by the laser apparatus 4 is approximately equal to a minimum fluence integration threshold (in current embodiment, the minimum fluence integration threshold is greater than zero). In FIG. 9A, the laser pulse integration distribution of laser processing performed by the laser apparatus 4 in the region 66 is greater than the laser pulse integration distribution of laser processing performed by the laser apparatus 4 in the region 68 (approximately a constant value); and the laser pulse integration distribution of laser processing performed by the laser apparatus 4 in the region 67 is greater than the laser pulse integration distribution of laser processing performed by the laser apparatus 4 in the region 66. Since the fluence integration distribution=
the laser pulse integration distribution×the fluence F; hence, in current embodiment, the method for laser processing wafer surface of the present invention controls the overlapping rate of the laser pulses along the laser processing path direction of the laser processing path and the overlapping rate of the laser pulses along the separation direction of two adjacent laser processing paths, so that the laser pulse integration distribution of laser processing performed by the laser apparatus 4 in the region 66 can be controlled to be greater than the laser pulse integration distribution of laser processing performed by the laser apparatus 4 in the region 68 (approximately a constant value); and the laser pulse integration distribution of laser processing performed by the laser apparatus 4 in the region 67 can be controlled to be greater than the laser pulse integration distribution of laser processing performed by the laser apparatus 4 in the region 66. Since the fluence F of the laser apparatus 4 is controlled to be a constant value (when the fluence F of the laser apparatus 4 is controlled to be a constant value, the fluence integration distribution is proportional to the laser pulse integration distribution); hence, the fluence integration distribution of laser processing performed by the laser apparatus 4 in the region 66 can be controlled to be greater than the fluence integration distribution of laser processing performed by the laser apparatus 4 in the region 68 (approximately equal to a minimum fluence integration threshold), and the fluence integration distribution of laser processing performed by the laser apparatus 4 in the region 67 can be controlled to be greater than the fluence integration distribution of laser processing performed by the laser apparatus 4 in the region 66. Therefore, it can be achieved that when the profile distribution of the top surface 60 of the wafer 6 is greater than the minimum height threshold, where the profile distribution of the top surface 60 of the wafer 6 is higher, the fluence integration distribution of laser processing performed by the laser apparatus 4 is approximately higher.

In some embodiments, when the profile distribution of the top surface 60 of the wafer 6 in a region is smaller than or equal to the minimum height threshold TL, it can be chosen not to perform laser processing in that region (i.e. the minimum fluence integration threshold is equal to zero).

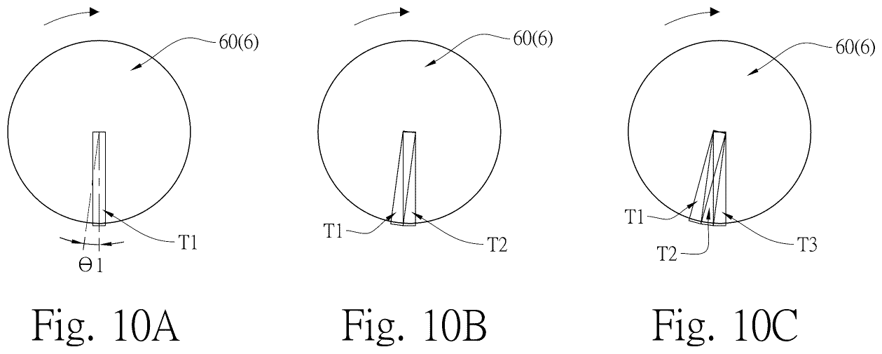

Please refer to FIGS. 10A-10C, which show schematic views of another embodiment of a scanning path when the laser processing system for wafer surface in FIG. 1 performing profile scanning. The scanning path in FIGS. 10A-10C is at least suitable for the scanning length SL of the scanning device 3 (line scanner) greater than a radius of the wafer 6 and smaller than a diameter of the wafer 6. In current embodiment, the motion driving apparatus 2 comprises a three-axis (including an X-axis positioning stage, a Y-axis positioning stage and a Z-axis positioning stage) positioning stage and a rotational stage (not shown in Figure), wherein the rotational stage is disposed on the three-axis positioning stage, and the carrying device 5 is disposed on the rotational stage. The wafer 6 carried by the carrying device 5 can be rotated relative to the Z-axis passing through a center of the rotational stage (or passing through a center of the wafer 6) by the rotational stage. The three-axis (the X-axis positioning stage, the Y-axis positioning stage and the Z-axis positioning stage) positioning stage and the rotational stage enables a relative displacement (linear displacement) and a relative rotation between the wafer 6 carried by the carrying device 5 and the scanning device 3 or between the wafer 6 carried by the carrying device 5 and the laser apparatus 4. The motion driving apparatus 2 moves the wafer 6 carried by the carrying device 5 along the Z-axis direction, such that the wafer 6 is moved to a height required for scanning by the scanning device 3. And the motion driving apparatus 2 moves the wafer 6 carried by the carrying device 5 along the X-axis direction and the Y-axis direction and rotates the wafer 6 carried by the carrying device 5 relative to the Z-axis, so that a geometric center of a first rectangle T1 is located directly below the scanning center of the scanning device 3 (line scanner), and such that the scanning range of the scanning device 3 (line scanner) is coincident with the first rectangle T1, and then the scanning device 3 performs a first profile scanning (a single profile scanning; as shown in FIG. 10A). Then the rotational stage of the motion driving apparatus 2 rotates the wafer 6 relative to the Z-axis clockwise by an angle θ1, so that a geometric center of a second rectangle T2 is located directly below the scanning center of the scanning device 3 (line scanner), and such that the scanning range of the scanning device 3 (line scanner) is coincident with the second rectangle T2, and then the scanning device 3 performs a second profile scanning (a single profile scanning; as shown in FIG. 10B). Then again the rotational stage of the motion driving apparatus 2 rotates the wafer 6 relative to the Z-axis clockwise by an angle θ1, so that a geometric center of a third rectangle T3 is located directly below the scanning center of the scanning device 3 (line scanner), and such that the scanning range of the scanning device 3 (line scanner) is coincident with the third rectangle T3, and then the scanning device 3 performs a third profile scanning (a single profile scanning; as shown in FIG. 10C). And so on, sequentially rotating the wafer 6 relative to the Z-axis clockwise by an angle θ1 one by one, and then the scanning device 3 performs a single profile scanning one by one. After the scanning device 3 completely scanning the top surface 60 of the wafer 6, the scanned results are integrated into a profile distribution of the top surface 60 of the wafer 6.

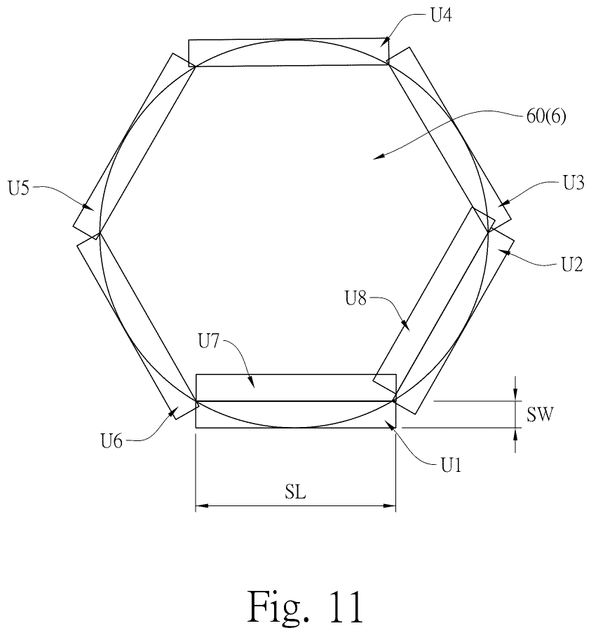

Please refer to FIG. 11, which is a schematic view of another embodiment of a scanning path when the laser processing system for wafer surface in FIG. 1 performing profile scanning. A plurality of identical rectangles (U1-U8) is shown in FIG. 11. Each of the rectangles has a length equal to a scanning length SL of the scanning device 3 (line scanner). Each of the rectangles has a width equal to a scanning width SW of the scanning device 3 (line scanner). In current embodiment, the motion driving apparatus 2 comprises a three-axis (including an X-axis positioning stage, a Y-axis positioning stage and a Z-axis positioning stage) positioning stage and a rotational stage (not shown in Figure), wherein the rotational stage is disposed on the three-axis positioning stage, and the carrying device 5 is disposed on the rotational stage. The wafer 6 carried by the carrying device 5 can be rotated relative to the Z-axis passing through a center of the rotational stage (or passing through a center of the wafer 6) by the rotational stage. The motion driving apparatus 2 moves the wafer 6 carried by the carrying device 5 along the Z-axis direction, such that the wafer 6 is moved to a height required for scanning by the scanning device 3. And the motion driving apparatus 2 moves the wafer 6 carried by the carrying device 5 along the X-axis direction and the Y-axis direction and rotates the wafer 6 carried by the carrying device 5 relative to the Z-axis, so that a geometric center of a rectangle U1 is located directly below a scanning center of the scanning device 3 (line scanner), and such that the scanning range of the scanning device 3 (line scanner) is coincident with the rectangle U1, and then the scanning device 3 performs a single profile scanning. Then the motion driving apparatus 2 sequentially moves and rotates the wafer 6 carried by the carrying device 5, so that a geometric center of the rectangles U2-U8 is moved to directly below the scanning center of the scanning device 3 (line scanner) one by one (so that the scanning range of the scanning device 3 (line scanner) is coincident with each of the rectangles U2-U8), and then the scanning device 3 performs a single profile scanning one by one. And then, the scanning range of the scanning device 3 is gradually retracted toward a center of the wafer 6, so that the scanning path of the scanning device 3 is similar to a spiral that is gradually retracted toward the center of the wafer 6.

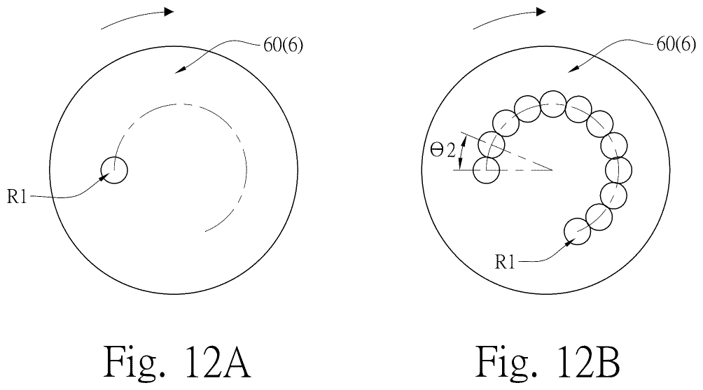

Please refer to FIGS. 12A-12B, which show schematic views of another embodiment of a laser pulse integration distribution when the laser processing system for wafer surface in FIG. 1 performing laser processing. In current embodiment, the motion driving apparatus 2 comprises a three-axis (including an X-axis positioning stage, a Y-axis positioning stage and a Z-axis positioning stage) positioning stage and a rotational stage (not shown in Figure), wherein the rotational stage is disposed on the three-axis positioning stage, and the carrying device 5 is disposed on the rotational stage. The wafer 6 carried by the carrying device 5 can be rotated relative to the Z-axis passing through a center of the rotational stage (or passing through a center of the wafer 6) by the rotational stage. The three-axis (the X-axis positioning stage, the Y-axis positioning stage and the Z-axis positioning stage) positioning stage and the rotational stage enables a relative displacement (linear displacement) and a relative rotation between the wafer 6 carried by the carrying device 5 and the scanning device 3 or between the wafer 6 carried by the carrying device 5 and the laser apparatus 4. The motion driving apparatus 2 moves the wafer 6 carried by the carrying device 5 along the Z-axis direction, such that the wafer 6 is moved to a height required for laser processing by the laser apparatus 4. And the motion driving apparatus 2 moves the wafer 6 carried by the carrying device 5 along the X-axis direction and/or the Y-axis direction, such that the wafer 6 is moved below the laser apparatus 4, and then the laser apparatus 4 starts performing laser processing on the wafer 6 from the top surface 60 of the wafer 6. The first laser pulse RI (as shown in FIG. 12A) is generated by the laser apparatus 4, and then as the rotational stage of the motion driving apparatus 2 rotates the wafer 6 relative to the Z-axis clockwise, laser processing is performed while the wafer 6 is rotating (the laser pulses are generated by the laser apparatus 4 while the wafer 6 is rotating), such that each time the wafer 6 is rotated relative to the Z-axis clockwise by an angle θ2, the laser apparatus 4 generates a laser pulse. Therefore, when the wafer 6 is rotated relative to the Z-axis clockwise to an angle of 11×θ2, the laser pulse integration distribution of laser processing performed by the laser apparatus 4 is as shown in FIG. 12B.

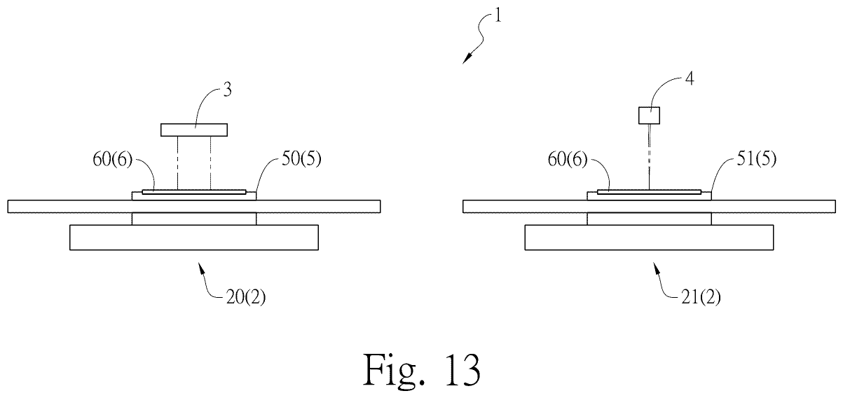

Please refer to FIG. 13, which is a cross-sectional schematic view of another embodiment of a laser processing system for wafer surface of the present invention. The main structure of the embodiment of FIG. 13 is basically the same as the structure of the embodiment of FIG. 1, except that the motion driving apparatus 2 comprises a scanning motion driving device 20 and a processing motion driving device 21, the carrying device 5 comprises a scanning wafer carrier 50 disposed on the scanning motion driving device 20 and a processing wafer carrier 51 disposed on the processing motion driving device 21, wherein the scanning motion driving device 20 and the processing motion driving device 21 are independent devices. The scanning wafer carrier 50 and the processing wafer carrier 51 are used for carrying the wafer 6. In current embodiment, the scanning motion driving device 20 and the processing motion driving device 21 are respectively a three-axis (including an X-axis positioning stage, a Y-axis positioning stage and a Z-axis positioning stage) positioning stage. Moreover, the present invention further provides a method for laser processing wafer surface, which comprises following steps of: Step A: providing a wafer 6 on a scanning wafer carrier 50 (the carrying device 5) which is disposed on a scanning motion driving device 20 (the motion driving apparatus 2), such that the wafer 6 is carried by the scanning wafer carrier 50; Step B: performing profile scanning a top surface 60 of the wafer 6 by a scanning device 3 to obtain a profile distribution of the top surface 60 of the wafer 6, wherein the scanning motion driving device 20 enables a relative displacement between the scanning device 3 and the wafer 6 carried by the scanning wafer carrier 50 along any direction of the X-axis direction, the Y-axis direction and the Z-axis direction; Step C0: moving the wafer 6 from the scanning wafer carrier 50 to a processing wafer carrier 51 (the carrying device 5) disposed on a processing motion driving device 21 (the motion driving apparatus 2), such that the wafer 6 is carried by the processing wafer carrier 51; and Step C: performing laser processing on the wafer 6 from the top surface 60 of the wafer 6 by a laser apparatus 4 with a fluence integration distribution to form a laser-processed wafer, wherein the fluence integration distribution of laser processing performed by the laser apparatus 4 is related to the profile distribution of the top surface 60 of the wafer 6. According to different situations and different needs, the condition that the fluence integration distribution of laser processing performed by the laser apparatus 4 and the profile distribution of the top surface 60 of the wafer 6 met can be chosen from at least the six conditions mentioned above. The processing motion driving device 21 enables the relative displacement between the wafer 6 and the laser apparatus 4 along any direction of the X-axis direction, the Y-axis direction and the Z-axis direction.

In some embodiments, the scanning motion driving device 20 comprises a three-axis (including an X-axis positioning stage, a Y-axis positioning stage and a Z-axis positioning stage) positioning stage and a rotational stage (not shown in Figure), wherein the rotational stage is disposed on the three-axis positioning stage, and the scanning wafer carrier 50 is disposed on the rotational stage. The wafer 6 carried by the scanning wafer carrier 50 can be rotated relative to the Z-axis passing through a center of the rotational stage (or passing through a center of the wafer 6) by the rotational stage. The three-axis (the X-axis positioning stage, the Y-axis positioning stage and the Z-axis positioning stage) positioning stage and the rotational stage enables a relative displacement (linear displacement) and a relative rotation between the wafer 6 carried by the scanning wafer carrier 50 and the scanning device 3. In some other embodiments, the processing motion driving device 21 comprises a three-axis (including an X-axis positioning stage, a Y-axis positioning stage and a Z-axis positioning stage) positioning stage and a rotational stage (not shown in Figure), wherein the rotational stage is disposed on the three-axis positioning stage, and the processing wafer carrier 51 is disposed on the rotational stage. The wafer 6 carried by the processing wafer carrier 51 can be rotated relative to the Z-axis passing through a center of the rotational stage (or passing through a center of the wafer 6) by the rotational stage. The three-axis (the X-axis positioning stage, the Y-axis positioning stage and the Z-axis positioning stage) positioning stage and the rotational stage enables a relative displacement (linear displacement) and a relative rotation between the wafer 6 carried by the processing wafer carrier 51 and the laser apparatus 4. In some other embodiments, the scanning motion driving device 20 comprises a three-axis (including an X-axis positioning stage, a Y-axis positioning stage and a Z-axis positioning stage) positioning stage and a rotational stage (not shown in Figure) and the processing motion driving device 21 comprises a three-axis (including an X-axis positioning stage, a Y-axis positioning stage and a Z-axis positioning stage) positioning stage and a rotational stage (not shown in Figure), wherein the rotational stage of the scanning motion driving device 20 is disposed on the three-axis positioning stage of the scanning motion driving device 20, and the scanning wafer carrier 50 is disposed on the rotational stage of the scanning motion driving device 20, the wafer 6 carried by the scanning wafer carrier 50 can be rotated relative to the Z-axis passing through a center of the rotational stage of the scanning motion driving device 20 (or passing through a center of the wafer 6 carried by the scanning wafer carrier 50) by the rotational stage of the scanning motion driving device 20, and wherein the rotational stage of the processing motion driving device 21 is disposed on the three-axis positioning stage of the processing motion driving device 21, and the processing wafer carrier 51 is disposed on the rotational stage of the processing motion driving device 21, the wafer 6 carried by the processing wafer carrier 51 can be rotated relative to the Z-axis passing through a center of the rotational stage of the processing motion driving device 21 (or passing through a center of the wafer 6 carried by the processing wafer carrier 51) by the rotational stage of the processing motion driving device 21. The three-axis (the X-axis positioning stage, the Y-axis positioning stage and the Z-axis positioning stage) positioning stage and the rotational stage of the scanning motion driving device 20 enables a relative displacement (linear displacement) and a relative rotation between the wafer 6 carried by the scanning wafer carrier 50 and the scanning device 3. The three-axis (the X-axis positioning stage, the Y-axis positioning stage and the Z-axis positioning stage) positioning stage and the rotational stage of the processing motion driving device 21 enables a relative displacement (linear displacement) and a relative rotation between the wafer 6 carried by the processing wafer carrier 51 and the laser apparatus 4.

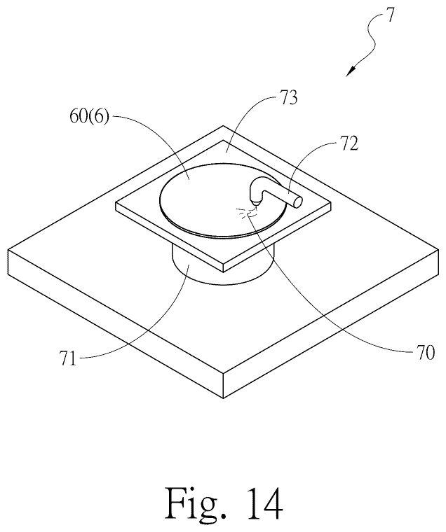

Please refer to FIG. 14, which is a perspective schematic view of a coating device of a laser processing system for wafer surface of the present invention. A coating device 7 comprises a coating wafer carrier 73, a rotational stage 71 and a nozzle 72. The coating wafer carrier 73 is disposed on the rotational stage 71. The coating wafer carrier 73 is used for carrying the wafer 6. The nozzle 72 is used for supplying an assisted modifying material 70 on a top surface 60 of the wafer 6. The rotational stage 71 can rotate the coating wafer carrier 73 (the wafer 6 carried by the coating wafer carrier 73), such that the assisted modifying material 70 is uniformly coated on the top surface 60 of the wafer 6 to form an assisted modifying layer on the top surface 60 of the wafer 6. In current embodiment, the wafer 6 may be a wafer that has not yet been lapped (for example, the wafers have been cut into slices from the ingot but have not yet been lapped), wherein the wafer 6 is made of SiC. Before the Step C (usually after the Step B and before the Step C), the method for laser processing wafer surface of the present invention further comprises a following step of: coating an assisted modifying layer on the top surface 60 of the wafer 6. Since SiC is very hard, the assisted modifying material 70 is first coated on the top surface 60 of the wafer 6 to form an assisted modifying layer on the top surface 60 of the wafer 6, wherein the coated assisted modifying layer can modify the material (SiC) properties of the wafer 6 adjacent the top surface 60 of the wafer 6, and makes the wafer 6 adjacent the top surface 60 of the wafer 6 becomes softer, so as to improve the efficiency of laser processing in the Step C. After the assisted modifying material 70 is coated on the top surface 60 of the wafer 6 and the assisted modifying layer is formed on the top surface 60 of the wafer 6, then performs the Step C (performing laser processing on the wafer 6 from the top surface 60 of the wafer 6 by a laser apparatus 4 with a fluence integration distribution to form a laser-processed wafer, wherein the fluence integration distribution of laser processing performed by the laser apparatus 4 is related to the profile distribution of the top surface 60 of the wafer 6. The condition that the fluence integration distribution of laser processing performed by the laser apparatus 4 and the profile distribution of the top surface 60 of the wafer 6 met can be chosen from at least the first condition, the second condition, the third condition and the fourth condition mentioned above.

In some embodiments, the assisted modifying material 70 (the assisted modifying layer) is made of a mixture of a solution containing metal ions, an oxidant and a buffer, wherein the solution containing metal ions is made of at least one material selected from the group consisting of: a solution of Ag³⁺ ions and a solution of Cu²⁺ ions; wherein the oxidant is hydrogen peroxide; wherein the buffer is glacial acetic acid. In some other embodiments, the assisted modifying material 70 (the assisted modifying layer) is made of an alkaline solution or colloid, wherein the alkaline solution or colloid is made of at least one material selected from the group consisting of: potassium hydroxide and ammonia. In some other embodiments, the assisted modifying material 70 (the assisted modifying layer) is made of at least one of a sol-gel containing at least one metal and a sol-gel containing an oxide of the at least one metal, wherein the at least one metal is at least one of Al, B, Ga and In, wherein the oxide of the at least one metal is at least one of aluminum oxide, boron oxide, gallium oxide and indium oxide.

In some embodiments, the coating device 7 in FIG. 14 can be used with the laser processing system 1 of FIGS. 1, 2 and 5. First use the scanning device 3 to scan the top surface 60 of the wafer 6 carried by the carrying device 5 in FIGS. 1 and 2 to obtain the profile distribution of the top surface 60 of the wafer 6; then move the wafer 6 from the carrying device 5 to the coating wafer carrier 73 of the coating device 7, such that the wafer 6 is carried by the coating wafer carrier 73; then coat the assisted modifying material 70 (the assisted modifying layer) on the top surface 60 of the wafer 6; then move the wafer 6 from the coating wafer carrier 73 to the carrying device 5 in FIGS. 1 and 5, such that the wafer 6 is carried by the carrying device 5; then perform laser processing on the wafer 6 from the top surface 60 of the wafer 6 by a laser apparatus 4 with a fluence integration distribution to form a laser-processed wafer, according to the profile distribution of the top surface 60 of the wafer 6.

In some other embodiments, the coating device 7 in FIG. 14 can be used with the laser processing system 1 of FIG. 13. First use the scanning device 3 to scan the top surface 60 of the wafer 6 carried by the scanning wafer carrier 50 in FIG. 13 to obtain the profile distribution of the top surface 60 of the wafer 6; then move the wafer 6 from the scanning wafer carrier 50 to the coating wafer carrier 73 of the coating device 7, such that the wafer 6 is carried by the coating wafer carrier 73; then coat the assisted modifying material 70 (the assisted modifying layer) on the top surface 60 of the wafer 6; then move the wafer 6 from the coating wafer carrier 73 to the processing wafer carrier 51 in FIG. 13, such that the wafer 6 is carried by the processing wafer carrier 51; then perform laser processing on the wafer 6 from the top surface 60 of the wafer 6 by a laser apparatus 4 with a fluence integration distribution to form a laser-processed wafer, according to the profile distribution of the top surface 60 of the wafer 6.

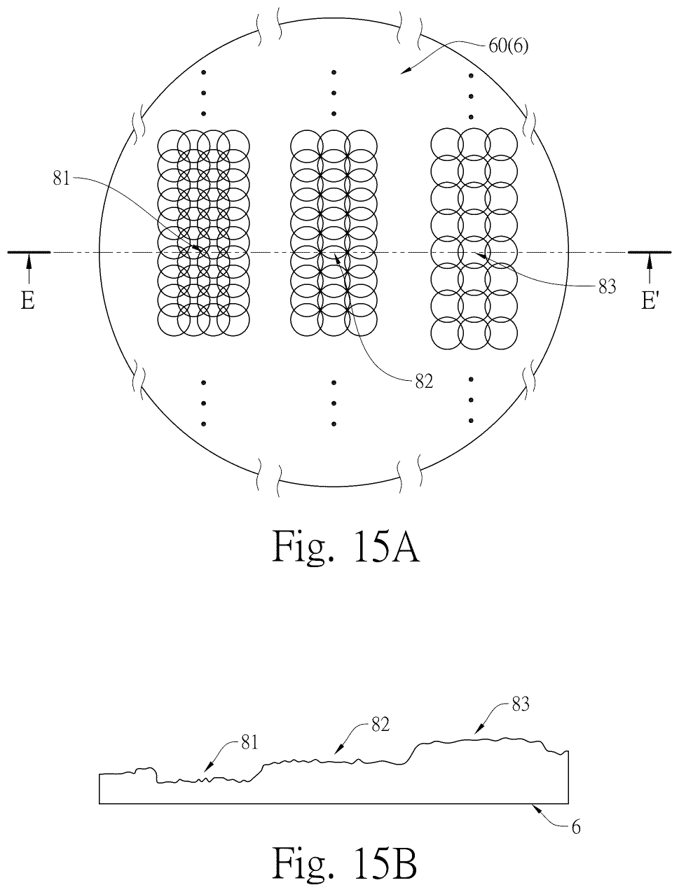

Please refer to FIG. 15A, which is a schematic view of another embodiment of a laser pulse integration distribution when the laser processing system for wafer surface in FIG. 1 performing laser processing. Please also refer to FIG. 15B, which is a cross-sectional schematic view of the profile distribution of the top surface of the wafer along the E-E′ section line in FIG. 15A, wherein the profile distribution of the top surface of the wafer is obtained after scanning by a scanning device before laser processing is performed on the wafer in FIG. 15A. In current embodiment, in the Step B of the method for laser processing wafer surface of the present invention, the top surface 60 of the wafer 6 can be completely scanned by the scanning device 3 to obtain the complete profile distribution of the top surface 60 of the wafer 6; wherein FIG. 15B only shows a cross-sectional schematic view of the profile distribution of the top surface 60 of the wafer 6 along the E-E′ section line in FIG. 15A. In the Step C, laser processing is performed on the wafer 6 from the top surface 60 of the wafer 6 by a laser apparatus 4 with a fluence integration distribution to form a laser-processed wafer, according to the profile distribution of the top surface 60 of the wafer 6. In current embodiment, the fifth condition of the six conditions mentioned above is selected as the condition that the fluence integration distribution of laser processing performed by the laser apparatus 4 and the profile distribution of the top surface 60 of the wafer 6 met, wherein the fifth condition is as the following: where the profile distribution of the top surface 60 of the wafer 6 is higher, the fluence integration distribution of laser processing performed by the laser apparatus 4 is approximately lower. FIGS. 15A and 15B show that the top surface 60 of the wafer 6 includes a region 81, a region 82 and a region 83. FIG. 15B shows that the profile distribution of the region 81 is roughly smaller than the profile distribution of the region 82; the profile distribution of the region 82 is roughly smaller than the profile distribution of the region 83. In current embodiment, when performing laser processing, the fluence F of the laser apparatus 4 is controlled to be a constant value. FIG. 15A shows that the laser pulse integration distribution of the laser pulses in the region 81 is greater than the laser pulse integration distribution of the laser pulses in the region 82, and the laser pulse integration distribution of the laser pulses in the region 82 is greater than the laser pulse integration distribution of the laser pulses in the region 83. Since

the fluence integration distribution=the laser pulse integration distribution×the fluence F;

hence, in current embodiment, the method for laser processing wafer surface of the present invention controls the overlapping rate of the laser pulses along the laser processing path direction of the laser processing path and the overlapping rate of the laser pulses along the separation direction of two adjacent laser processing paths, so that the laser pulse integration distribution of laser processing performed by the laser apparatus 4 in the region 81 can be controlled to be greater than the laser pulse integration distribution of laser processing performed by the laser apparatus 4 in the region 82, and the laser pulse integration distribution of laser processing performed by the laser apparatus 4 in the region 82 can be controlled to be greater than the laser pulse integration distribution of laser processing performed by the laser apparatus 4 in the region 83. Since the fluence F of the laser apparatus 4 is controlled to be a constant value; hence, the fluence integration distribution of laser processing performed by the laser apparatus 4 in the region 81 can be controlled to be greater than the fluence integration distribution of laser processing performed by the laser apparatus 4 in the region 82, and the fluence integration distribution of laser processing performed by the laser apparatus 4 in the region 82 can be controlled to be greater than the fluence integration distribution of laser processing performed by the laser apparatus 4 in the region 83. Therefore, it can be achieved that when performing laser processing by the laser apparatus 4, it is based on that where the profile distribution of the top surface 60 of the wafer 6 is higher, the fluence integration distribution of laser processing performed by the laser apparatus 4 is approximately lower.

In some embodiments, in the Step C of the method for laser processing wafer surface of the present invention, laser processing is performed on the wafer 6 from the top surface 60 of the wafer 6 by a laser apparatus 4 with a fluence integration distribution to form a laser-processed wafer, wherein the sixth condition of the six conditions mentioned above is selected as the condition that the fluence integration distribution of laser processing performed by the laser apparatus 4 and the profile distribution of the top surface 60 of the wafer 6 met, wherein the sixth condition is as the following: the profile distribution of the top surface 60 of the wafer 6 has a maximum value and a minimum value, a difference of the maximum value and the minimum value of the profile distribution of the top surface 60 of the wafer 6 is defined as a high-low range of the profile distribution of the top surface 60 of the wafer 6, a difference of the profile distribution of the top surface 60 of the wafer 6 and the minimum value of the profile distribution of the top surface 60 of the wafer 6 is defined as a normalized profile distribution of the top surface 60 of the wafer 6, a ratio of the normalized profile distribution of the top surface 60 of the wafer 6 to the high-low range of the profile distribution of the top surface 60 of the wafer 6 is defined as a normalized-profile proportion distribution of the top surface 60 of the wafer 6, wherein the fluence integration distribution of laser processing performed by the laser apparatus 4 is approximately inversely proportional to the normalized-profile proportion distribution of the top surface 60 of the wafer 6.

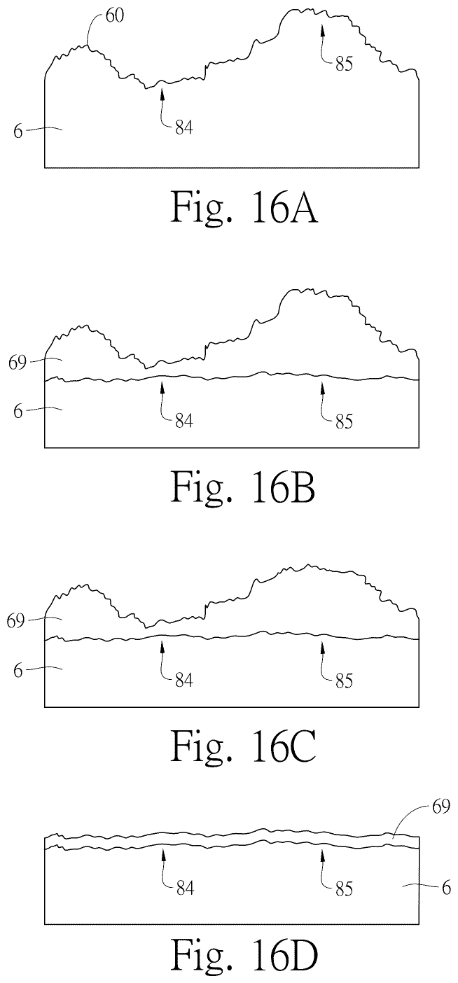

Please refer to FIG. 16A, which is a cross-sectional schematic view of the profile distribution of the top surface of the SiC wafer which has not yet been lapped, wherein the profile distribution is obtained after scanning the top surface of the SiC wafer by the method for laser processing wafer surface of the present invention. FIG. 16A shows that the wafer 6 includes a region 84 and a region 85, wherein the profile distribution of the top surface 60 of the wafer 6 in the region 85 is higher than the profile distribution of the top surface 60 of the wafer 6 in the region 84. In current embodiment, the wafer 6 may be a wafer that has not yet been lapped (for example, the wafers have been cut into slices from the ingot but have not yet been lapped), wherein the wafer 6 is made of SiC, wherein a bottom of the wafer 6 is usually not a flat plane as shown in FIG. 16A, and is usually also very uneven. After the wafers 6 have been cut into slices from the SiC ingot, since SiC is very hard, the cutting surface (for example, the top surface 60 of the wafer 6) is usually very uneven. Please also refer to FIG. 16B, which is a cross-sectional schematic view of the SiC wafer after the SiC wafer in FIG. 16A is laser processed by the method for laser processing wafer surface of the present invention. When the wafer 6 in FIG. 16A is laser processed using the method for laser processing wafer surface of the present invention, in the Step C, laser processing is performed on the wafer 6 from the top surface 60 of the wafer 6 by a laser apparatus 4 with a fluence integration distribution to form a laser-processed wafer, wherein the first condition of the six conditions mentioned above is selected as the condition that the fluence integration distribution of laser processing performed by the laser apparatus 4 and the profile distribution of the top surface 60 of the wafer 6 met, wherein the first condition is as the following: where the profile distribution of the top surface 60 of the wafer 6 is higher, the fluence integration distribution of laser processing performed by the laser apparatus 4 is approximately higher. After the method for laser processing wafer surface of the present invention performed the fluence integration distribution of laser processing on the wafer 6 from the top surface 60 of the wafer 6 by the laser apparatus 4, a modified layer 69 is formed adjacent to the top surface 60 of the wafer 6, wherein after the fluence integration distribution of laser processing is performed by the laser apparatus 4, the material properties of the SiC wafer 6 located at the modified layer 69 are changed, and the modified layer 69 with a softer hardness is formed. Since the fluence integration distribution of laser processing performed by the laser apparatus 4 is adjusted according to the profile distribution of the top surface 60 of the wafer 6, where the profile distribution of the top surface 60 of the wafer 6 is higher, the fluence integration distribution of laser processing performed by the laser apparatus 4 is approximately higher; hence, as shown in FIG. 16B, after the fluence integration distribution of laser processing is performed by the laser apparatus 4, a thickness of the modified layer 69 is also related to the profile distribution of the top surface 60 of the wafer 6. That is, where the profile distribution of the top surface 60 of the wafer 6 is higher, the thickness of the modified layer 69 is approximately higher. In this way, a bottom of the modified layer 69 can be maintained in approximately horizontal. Therefore, the modified layer 69 with a softer hardness can be finely polished directly by polishing process to form a polished surface. Therefore, the method for laser processing wafer surface of the present invention can indeed enhance laser modification in the location where the profile distribution of the top surface 60 of the wafer 6 is higher (where the profile distribution of the top surface 60 of the wafer 6 is higher, the fluence integration distribution of laser processing performed by the laser apparatus 4 is approximately higher), and can indeed reduce laser modification in the location where the profile distribution of the top surface 60 of the wafer 6 is lower (where the profile distribution of the top surface 60 of the wafer 6 is lower, the fluence integration distribution of laser processing performed by the laser apparatus 4 is approximately lower). Hence, the lapping process (which is time consuming and high abrasives consumption) can be improved, and at the same time, the overall loss rate of the wafer 6 can be reduced. Even further, the lapping process can be omitted and the polishing process can be performed directly with no need to perform the lapping process in advance.

In some embodiments, in the Step C of the method for laser processing wafer surface of the present invention, during performing laser processing, a portion of the wafer 6 adjacent to the top surface 60 of the wafer 6 is removed, such that the wafer 6 (the top surface 60 of the wafer 6) is at least partially planarized. Please refer to FIG. 16C, which is a cross-sectional schematic view of the SiC wafer after the SiC wafer in FIG. 16A is laser processed to be partially planarized by the method for laser processing wafer surface of the present invention. For example, in the embodiment of FIG. 16A, the fluence integration distribution of laser processing performed by the laser apparatus 4 in the region 85 is particularly high, which may result that a portion of the wafer 6 adjacent to the top surface 60 of the wafer 6 in the region 85 will be removed due to laser processing, such that the wafer 6 (the top surface 60 of the wafer 6) is partially planarized in the region 85 (For example, the thickness of the modified layer 69 in the region 85 in FIG. 16C is smaller than the thickness of the modified layer 69 in the region 85 in FIG. 16B; because a portion of the wafer 6 adjacent to the top surface 60 of the wafer 6 in the region 85 is removed due to laser processing; hence, the thickness of the modified layer 69 in the region 85 in FIG. 16C becomes smaller).

In the embodiment of FIGS. 9A and 9B, the laser pulse integration distribution of laser processing performed by the laser apparatus 4 in the region 67 is particularly high; that is, the fluence integration distribution of laser processing performed by the laser apparatus 4 in the region 67 is particularly high, which may result that a portion of the wafer 6 adjacent to the top surface 60 of the wafer 6 in the region 67 will be removed due to laser processing, such that the wafer 6 (the top surface 60 of the wafer 6) is partially planarized in the region 67.

In some embodiments, a portion of the wafer 6 adjacent to the top surface 60 of the wafer 6 that is removed due to laser processing is located in a region where the fluence integration distribution of laser processing performed by the laser apparatus 4 is relatively higher. However, it is not necessarily that in a region where the fluence integration distribution of laser processing performed by the laser apparatus 4 is high, a portion of the wafer 6 adjacent to the top surface 60 of the wafer 6 in that region will be removed due to laser processing such that the wafer 6 is partially planarized in that region.

In some embodiments, in the Step C of the method for laser processing wafer surface of the present invention, during performing laser processing, a large region of the wafer 6 adjacent to the top surface 60 of the wafer 6 is removed due to laser processing, such that the wafer 6 (the top surface 60 of the wafer 6) is globally planarized. Please refer to FIG. 16D, which is a cross-sectional schematic view of the SiC wafer after the SiC wafer in FIG. 16A is laser processed to be globally planarized by the method for laser processing wafer surface of the present invention. For example, in the embodiment of FIG. 16A, after the method for laser processing wafer surface of the present invention performed the fluence integration distribution of laser processing on the wafer 6 from the top surface 60 of the wafer 6 by the laser apparatus 4, a large region of the wafer 6 adjacent to the top surface 60 of the wafer 6 is removed due to laser processing, such that the wafer 6 (the top surface 60 of the wafer 6) is globally planarized and a modified layer 69 with a thinner thickness is formed (as shown in FIG. 16D).

The method for laser processing wafer surface of the present invention is very suitable for processing the wafers that have not yet been lapped. After the wafers were processed by the method for laser processing wafer surface of the present invention, the wafers do not need to be lapped; that is, the lapping process can be omitted. The wafers can be directly processed by the polishing process with no need to perform the lapping process in advance. Especially in the embodiment of FIG. 16D, after the method for laser processing wafer surface of the present invention performed the fluence integration distribution of laser processing on the wafer 6 from the top surface 60 of the wafer 6 by the laser apparatus 4, such that the wafer 6 (the top surface 60 of the wafer 6) is globally planarized and a modified layer 69 with a thinner thickness is formed. Then, the wafer 6 can be directly processed by the polishing process to form a polished surface. Furthermore, in the embodiments of FIGS. 16B and 16C, after the method for laser processing wafer surface of the present invention performed the fluence integration distribution of laser processing on the wafer 6 from the top surface 60 of the wafer 6 by the laser apparatus 4, the wafer 6 can also be directly processed by the polishing process to form a polished surface. In comparison, directly polishing the wafer 6 of the embodiment of FIG. 16D is the least time consuming and the least abrasives consumption, the embodiment of FIG. 16C is the second, and the embodiment of FIG. 16B is the third.

The method for laser processing wafer surface of the present invention is also suitable for the application of wafer reclaim. The present invention further provides a method for laser processing wafer surface, which comprises following steps of: Step A: providing a wafer that requires wafer reclaim processing; Step B: performing profile scanning a top surface of the wafer by a scanning device 3 to obtain a profile distribution of the top surface of the wafer; and Step C: performing laser processing on the wafer from the top surface of the wafer by a laser apparatus 4 with a fluence integration distribution to form a laser-processed wafer, wherein the fluence integration distribution of laser processing performed by the laser apparatus 4 is related to the profile distribution of the top surface of the wafer. In some embodiments, the condition that the fluence integration distribution of laser processing performed by the laser apparatus 4 and the profile distribution of the top surface of the wafer that requires wafer reclaim processing met can be chosen from at least the first condition, the second condition, the third condition and the fourth condition mentioned above.

In some embodiments, the motion driving apparatus 2 comprises a three-axis (including an X-axis positioning stage, a Y-axis positioning stage and a Z-axis positioning stage) positioning stage, wherein the scanning device 3 is disposed on the Z-axis positioning stage (not shown in Figure), the carrying device 5 is disposed on a combination of the X-axis positioning stage and the Y-axis positioning stage (not shown in Figure), wherein the wafer 6 carried by the carrying device 5 can be moved along the X-axis direction and/or the Y-axis direction by the combination of the X-axis positioning stage and the Y-axis positioning stage of the motion driving apparatus 2, and the scanning device 3 can be moved along the Z-axis direction by the Z-axis positioning stage of the motion driving apparatus 2. In some other embodiments, the motion driving apparatus 2 comprises a three-axis (including an X-axis positioning stage, a Y-axis positioning stage and a Z-axis positioning stage) positioning stage, wherein the laser apparatus 4 is disposed on the Z-axis positioning stage (not shown in Figure), the carrying device 5 is disposed on a combination of the X-axis positioning stage and the Y-axis positioning stage (not shown in Figure), wherein the wafer 6 carried by the carrying device 5 can be moved along the X-axis direction and/or the Y-axis direction by the combination of the X-axis positioning stage and the Y-axis positioning stage of the motion driving apparatus 2, and the laser apparatus 4 can be moved along the Z-axis direction by the Z-axis positioning stage of the motion driving apparatus 2. In some other embodiments, the motion driving apparatus 2 comprises a three-axis (including an X-axis positioning stage, a Y-axis positioning stage and a Z-axis positioning stage) positioning stage, wherein the scanning device 3 and the laser apparatus 4 are disposed on the Z-axis positioning stage (not shown in Figure), the carrying device 5 is disposed on a combination of the X-axis positioning stage and the Y-axis positioning stage (not shown in Figure), wherein the wafer 6 carried by the carrying device 5 can be moved along the X-axis direction and/or the Y-axis direction by the combination of the X-axis positioning stage and the Y-axis positioning stage of the motion driving apparatus 2, and the scanning device 3 and the laser apparatus 4 can be moved along the Z-axis direction by the Z-axis positioning stage of the motion driving apparatus 2.

In some embodiments, the motion driving apparatus 2 comprises a three-axis (including an X-axis positioning stage, a Y-axis positioning stage and a Z-axis positioning stage) positioning stage and a rotational stage (not shown in Figure), wherein the scanning device 3 is disposed on the Z-axis positioning stage (not shown in Figure), the carrying device 5 is disposed on the rotational stage, the rotational stage is disposed on a combination of the X-axis positioning stage and the Y-axis positioning stage (not shown in Figure), wherein the wafer 6 carried by the carrying device 5 can be moved along the X-axis direction and/or the Y-axis direction by the combination of the X-axis positioning stage and the Y-axis positioning stage of the motion driving apparatus 2 and/or can be rotated relative to the Z-axis passing through a center of the rotational stage (or passing through a center of the wafer 6) by the rotational stage of the motion driving apparatus 2, and the scanning device 3 can be moved along the Z-axis direction by the Z-axis positioning stage of the motion driving apparatus 2. In some embodiments, the motion driving apparatus 2 comprises a three-axis (including an X-axis positioning stage, a Y-axis positioning stage and a Z-axis positioning stage) positioning stage and a rotational stage (not shown in Figure), wherein the laser apparatus 4 is disposed on the Z-axis positioning stage (not shown in Figure), the carrying device 5 is disposed on the rotational stage, the rotational stage is disposed on a combination of the X-axis positioning stage and the Y-axis positioning stage (not shown in Figure), wherein the wafer 6 carried by the carrying device 5 can be moved along the X-axis direction and/or the Y-axis direction by the combination of the X-axis positioning stage and the Y-axis positioning stage of the motion driving apparatus 2 and/or can be rotated relative to the Z-axis passing through a center of the rotational stage (or passing through a center of the wafer 6) by the rotational stage of the motion driving apparatus 2, and the laser apparatus 4 can be moved along the Z-axis direction by the Z-axis positioning stage of the motion driving apparatus 2. In some embodiments, the motion driving apparatus 2 comprises a three-axis (including an X-axis positioning stage, a Y-axis positioning stage and a Z-axis positioning stage) positioning stage and a rotational stage (not shown in Figure), wherein the scanning device 3 and the laser apparatus 4 are disposed on the Z-axis positioning stage (not shown in Figure), the carrying device 5 is disposed on the rotational stage, the rotational stage is disposed on a combination of the X-axis positioning stage and the Y-axis positioning stage (not shown in Figure), wherein the wafer 6 carried by the carrying device 5 can be moved along the X-axis direction and/or the Y-axis direction by the combination of the X-axis positioning stage and the Y-axis positioning stage of the motion driving apparatus 2 and/or can be rotated relative to the Z-axis passing through a center of the rotational stage (or passing through a center of the wafer 6) by the rotational stage of the motion driving apparatus 2, and the scanning device 3 and the laser apparatus 4 can be moved along the Z-axis direction by the Z-axis positioning stage of the motion driving apparatus 2.

In some embodiments, the scanning motion driving device 20 comprises a three-axis (including an X-axis positioning stage, a Y-axis positioning stage and a Z-axis positioning stage) positioning stage, wherein the scanning device 3 is disposed on the Z-axis positioning stage of the scanning motion driving device 20 (not shown in Figure), the scanning wafer carrier 50 is disposed on a combination of the X-axis positioning stage and the Y-axis positioning stage of the scanning motion driving device 20 (not shown in Figure), wherein the wafer 6 carried by the scanning wafer carrier 50 can be moved along the X-axis direction and/or the Y-axis direction by the combination of the X-axis positioning stage and the Y-axis positioning stage of the scanning motion driving device 20, and the scanning device 3 can be moved along the Z-axis direction by the Z-axis positioning stage of the scanning motion driving device 20. In some other embodiments, the processing motion driving device 21 comprises a three-axis (including an X-axis positioning stage, a Y-axis positioning stage and a Z-axis positioning stage) positioning stage, wherein the laser apparatus 4 is disposed on the Z-axis positioning stage of the processing motion driving device 21 (not shown in Figure), the processing wafer carrier 51 is disposed on a combination of the X-axis positioning stage and the Y-axis positioning stage of the processing motion driving device 21 (not shown in Figure), wherein the wafer 6 carried by the processing wafer carrier 51 can be moved along the X-axis direction and/or the Y-axis direction by the combination of the X-axis positioning stage and the Y-axis positioning stage of the processing motion driving device 21, and the laser apparatus 4 can be moved along the Z-axis direction by the Z-axis positioning stage of the processing motion driving device 21. In some other embodiments, the scanning motion driving device 20 comprises a three-axis (including an X-axis positioning stage, a Y-axis positioning stage and a Z-axis positioning stage) positioning stage, the processing motion driving device 21 comprises a three-axis (including an X-axis positioning stage, a Y-axis positioning stage and a Z-axis positioning stage) positioning stage, wherein the scanning device 3 is disposed on the Z-axis positioning stage of the scanning motion driving device 20 (not shown in Figure), the scanning wafer carrier 50 is disposed on a combination of the X-axis positioning stage and the Y-axis positioning stage of the scanning motion driving device 20 (not shown in Figure), the laser apparatus 4 is disposed on the Z-axis positioning stage of the processing motion driving device 21 (not shown in Figure), the processing wafer carrier 51 is disposed on a combination of the X-axis positioning stage and the Y-axis positioning stage of the processing motion driving device 21 (not shown in Figure), wherein the wafer 6 carried by the scanning wafer carrier 50 can be moved along the X-axis direction and/or the Y-axis direction by the combination of the X-axis positioning stage and the Y-axis positioning stage of the scanning motion driving device 20, and the scanning device 3 can be moved along the Z-axis direction by the Z-axis positioning stage of the scanning motion driving device 20, wherein the wafer 6 carried by the processing wafer carrier 51 can be moved along the X-axis direction and/or the Y-axis direction by the combination of the X-axis positioning stage and the Y-axis positioning stage of the processing motion driving device 21, and the laser apparatus 4 can be moved along the Z-axis direction by the Z-axis positioning stage of the processing motion driving device 21. In some other embodiments, the processing motion driving device 21 can be replaced by a base (not shown in Figure) which cannot move at all, wherein the scanning wafer carrier 50 is disposed on the base, wherein during performing laser processing on the wafer 6 from the top surface 60 of the wafer 6 by the laser apparatus 4 with a fluence integration distribution to form a laser-processed wafer, the laser apparatus 4 doesn't need to move at all.

In some embodiments, the scanning motion driving device 20 comprises a three-axis (including an X-axis positioning stage, a Y-axis positioning stage and a Z-axis positioning stage) positioning stage and a rotational stage (not shown in Figure), wherein the scanning device 3 is disposed on the Z-axis positioning stage of the scanning motion driving device 20 (not shown in Figure), the scanning wafer carrier 50 is disposed on the rotational stage of the scanning motion driving device 20, the rotational stage of the scanning motion driving device 20 is disposed on a combination of the X-axis positioning stage and the Y-axis positioning stage of the scanning motion driving device 20 (not shown in Figure), wherein the wafer 6 carried by the scanning wafer carrier 50 can be moved along the X-axis direction and/or the Y-axis direction by the combination of the X-axis positioning stage and the Y-axis positioning stage of the scanning motion driving device 20 and/or can be rotated relative to the Z-axis passing through a center of the rotational stage of the scanning motion driving device 20 (or passing through a center of the wafer 6) by the rotational stage of the scanning motion driving device 20, and the scanning device 3 can be moved along the Z-axis direction by the Z-axis positioning stage of the scanning motion driving device 20. In some other embodiments, the processing motion driving device 21 comprises a three-axis (including an X-axis positioning stage, a Y-axis positioning stage and a Z-axis positioning stage) positioning stage and a rotational stage (not shown in Figure), wherein the laser apparatus 4 is disposed on the Z-axis positioning stage of the processing motion driving device 21 (not shown in Figure), the processing wafer carrier 51 is disposed on the rotational stage of the processing motion driving device 21, the rotational stage of the processing motion driving device 21 is disposed on a combination of the X-axis positioning stage and the Y-axis positioning stage of the processing motion driving device 21 (not shown in Figure), wherein the wafer 6 carried by the processing wafer carrier 51 can be moved along the X-axis direction and/or the Y-axis direction by the combination of the X-axis positioning stage and the Y-axis positioning stage of the processing motion driving device 21 and/or can be rotated relative to the Z-axis passing through a center of the rotational stage of the processing motion driving device 21 (or passing through a center of the wafer 6) by the rotational stage of the processing motion driving device 21, and the laser apparatus 4 can be moved along the Z-axis direction by the Z-axis positioning stage of the processing motion driving device 21. In some other embodiments, the scanning motion driving device 20 comprises a three-axis (including an X-axis positioning stage, a Y-axis positioning stage and a Z-axis positioning stage) positioning stage and a rotational stage (not shown in Figure), the processing motion driving device 21 comprises a three-axis (including an X-axis positioning stage, a Y-axis positioning stage and a Z-axis positioning stage) positioning stage and a rotational stage (not shown in Figure), wherein the scanning device 3 is disposed on the Z-axis positioning stage of the scanning motion driving device 20 (not shown in Figure), the scanning wafer carrier 50 is disposed on the rotational stage of the scanning motion driving device 20, the rotational stage of the scanning motion driving device 20 is disposed on a combination of the X-axis positioning stage and the Y-axis positioning stage of the scanning motion driving device 20 (not shown in Figure), the laser apparatus 4 is disposed on the Z-axis positioning stage of the processing motion driving device 21 (not shown in Figure), the processing wafer carrier 51 is disposed on the rotational stage of the processing motion driving device 21, the rotational stage of the processing motion driving device 21 is disposed on a combination of the X-axis positioning stage and the Y-axis positioning stage of the processing motion driving device 21 (not shown in Figure), wherein the wafer 6 carried by the scanning wafer carrier 50 can be moved along the X-axis direction and/or the Y-axis direction by the combination of the X-axis positioning stage and the Y-axis positioning stage of the scanning motion driving device 20 and/or can be rotated relative to the Z-axis passing through a center of the rotational stage of the scanning motion driving device 20 (or passing through a center of the wafer 6 carried by the scanning wafer carrier 50) by the rotational stage of the scanning motion driving device 20, and the scanning device 3 can be moved along the Z-axis direction by the Z-axis positioning stage of the scanning motion driving device 20, wherein the wafer 6 carried by the processing wafer carrier 51 can be moved along the X-axis direction and/or the Y-axis direction by the combination of the X-axis positioning stage and the Y-axis positioning stage of the processing motion driving device 21 and/or can be rotated relative to the Z-axis passing through a center of the rotational stage of the processing motion driving device 21 (or passing through a center of the wafer 6 carried by the processing wafer carrier 51) by the rotational stage of the processing motion driving device 21, and the laser apparatus 4 can be moved along the Z-axis direction by the Z-axis positioning stage of the processing motion driving device 21.

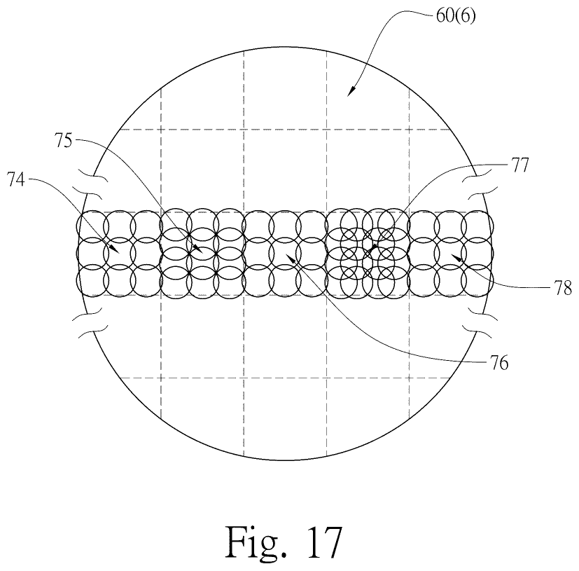

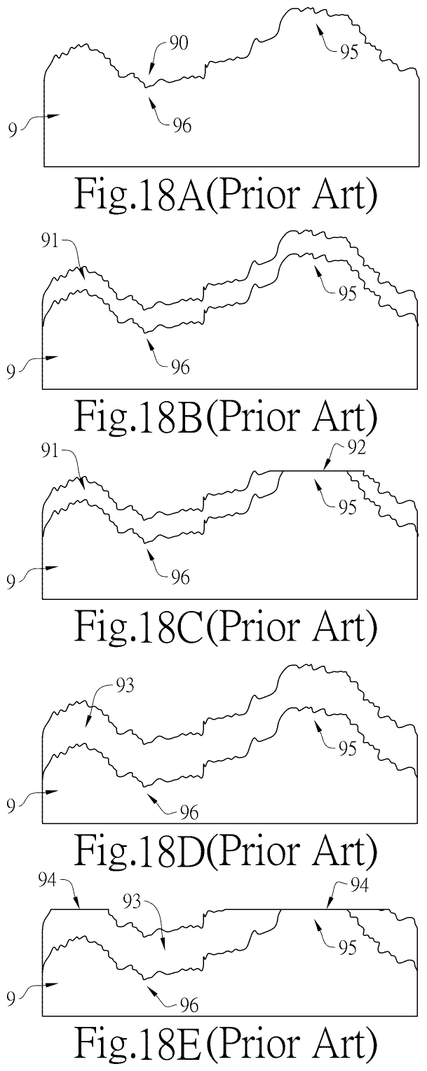

Please refer to FIG. 17, which is a schematic view of another embodiment of a laser pulse integration distribution when the laser processing system for wafer surface in FIG. 1 performing laser processing. In current embodiment, the scanning device 3 is a sensor, wherein the sensor can be a distance sensor or a height sensor. The method for laser processing wafer surface of the present invention comprises following steps of: Step A: providing a wafer 6 on a carrying device 5 which is disposed on a motion driving apparatus 2, such that the wafer 6 is carried by the carrying device 5; Step B: performing profile scanning a top surface 60 of the wafer 6 by a scanning device 3 to obtain a profile distribution of the top surface 60 of the wafer 6; and Step C: performing laser processing on the wafer 6 from the top surface 60 of the wafer 6 by a laser apparatus 4 with a fluence integration distribution to form a laser-processed wafer, according to the profile distribution of the top surface 60 of the wafer 6. In FIG. 17, the top surface 60 of the wafer 6 is roughly divided into 25 regions separated by dotted lines (including a region 74, a region 74, a region 74, a region 74, a region 74 and twenty other unnumbered regions). Each of the 25 regions has a to-be-measured point. In the Step B, when the scanning device 3 performs profile scanning, the motion driving apparatus 2 enables relative displacements between the wafer 6 carried by the carrying device 5 respectively, such that the 25 to-be-measured points are located directly below the scanning device 3 respectively, and the scanning device 3 (sensor) measures at the 25 to-be-measured points respectively to obtain 25 profile values of the 25 to-be-measured points respectively (each to-be-measured point has a profile value). The to-be-measured point of the region may be a geometric center point of the region, a point adjacent to the geometric center point of the region, or a point in the region suitable for measurement. The 25 profile values form a profile distribution of the top surface 60 of the wafer 6. The profile values measured by the scanning device 3 (sensor) at the to-be-measured point of the region 74, the to-be-measured point of the region 76 and the to-be-measured point of the region 78 are approximately the same. The profile value measured by the scanning device 3 (sensor) at the to-be-measured point of the region 75 is greater than the profile values measured by the scanning device 3 (sensor) at the to-be-measured point of the region 74, the to-be-measured point of the region 76 and the to-be-measured point of the region 78. The profile value measured by the scanning device 3 (sensor) at the to-be-measured point of the region 77 is greater than the profile value measured by the scanning device 3 (sensor) at the to-be-measured point of the region 75. In current embodiment, the first condition of the six conditions mentioned above is selected as the condition that the fluence integration distribution of laser processing performed by the laser apparatus 4 and the profile distribution of the top surface 60 of the wafer 6 met, wherein the first condition is as the following: where the profile distribution of the top surface 60 of the wafer 6 is higher, the fluence integration distribution of laser processing performed by the laser apparatus 4 is approximately higher. In current embodiment, when performing laser processing, the fluence F of the laser apparatus 4 is controlled to be a constant value. In FIG. 17, the laser pulse integration distributions of laser processing performed by the laser apparatus 4 in the region 74, the region 76 and the region 78 are approximately the same. The laser pulse integration distributions of laser processing performed by the laser apparatus 4 in the region 74, the region 76 and the region 78 are smaller than the laser pulse integration distribution of laser processing performed by the laser apparatus 4 in the region 75. The laser pulse integration distribution of laser processing performed by the laser apparatus 4 in the region 75 is smaller than the laser pulse integration distribution of laser processing performed by the laser apparatus 4 in the region 77. Since

$$the fluence integration distribution = the laser pulse integration distribution \times the fluence F ;$$

hence, in current embodiment, the method for laser processing wafer surface of the present invention controls the overlapping rate of the laser pulses along the laser processing path direction of the laser processing path and the overlapping rate of the laser pulses along the separation direction of two adjacent laser processing paths, so that the laser pulse integration distributions of laser processing performed by the laser apparatus 4 in the region 74, the region 76 and the region 78 can be controlled to be approximately the same, the laser pulse integration distributions of laser processing performed by the laser apparatus 4 in the region 74, the region 76 and the region 78 can be controlled to be smaller than the laser pulse integration distribution of laser processing performed by the laser apparatus 4 in the region 75, and the laser pulse integration distribution of laser processing performed by the laser apparatus 4 in the region 75 can be controlled to be smaller than the laser pulse integration distribution of laser processing performed by the laser apparatus 4 in the region 77. Since the fluence F of the laser apparatus 4 is controlled to be a constant value; hence, the fluence integration distributions of laser processing performed by the laser apparatus 4 in the region 74, the region 76 and the region 78 can be controlled to be approximately the same, the fluence integration distributions of laser processing performed by the laser apparatus 4 in the region 74, the region 76 and the region 78 can be controlled to be smaller than the fluence integration distribution of laser processing performed by the laser apparatus 4 in the region 75, and the fluence integration distribution of laser processing performed by the laser apparatus 4 in the region 75 can be controlled to be smaller than the fluence integration distribution of laser processing performed by the laser apparatus 4 in the region 77. Therefore, it can be achieved that when performing laser processing by the laser apparatus 4, it is based on that where the profile distribution of the top surface 60 of the wafer 6 is higher, the fluence integration distribution of laser processing performed by the laser apparatus 4 is approximately higher. In current embodiment, the scanning device 3 (sensor) only needs to measure at the 25 to-be-measured points respectively to obtain 25 profile values of the 25 to-be-measured points respectively. Hence, the scanning speed is very fast and a lot of time and cost can be saved.

In some embodiments, the scanning device 3 is a sensor, wherein the sensor can be a distance sensor or a height sensor, wherein the top surface 60 of the wafer 6 is roughly divided into N regions, N is greater than 25, each of the N regions has a to-be-measured point, the scanning device 3 (sensor) measures at the N to-be-measured points respectively to obtain N profile values of the N to-be-measured points respectively. In some other embodiments, the scanning device 3 is a sensor, wherein the sensor can be a distance sensor or a height sensor, wherein the top surface 60 of the wafer 6 is roughly divided into N regions, N is smaller than 25, each of the N regions has a to-be-measured point, the scanning device 3 (sensor) measures at the N to-be-measured points respectively to obtain N profile values of the N to-be-measured points respectively. The value of N mentioned above depends on actual needs. The to-be-measured point of the region mentioned above may be a geometric center point of the region, a point adjacent to the geometric center point of the region, or a point in the region suitable for measurement.

In some embodiments, the scanning device 3 is a sensor array, the sensor array has N sensors, each of the sensors can be a distance sensor or a height sensor, wherein the top surface 60 of the wafer 6 is roughly divided into N regions, each of the N regions has a to-be-measured point, the positions of the N sensors of the sensor array are arranged to be respectively corresponding to the positions of the N to-be-measured points of the N regions. The N sensors of the sensor array (the scanning device 3) measure at the N to-be-measured points respectively to obtain N profile values of the N to-be-measured points respectively, wherein the to-be-measured point of the region mentioned above may be a geometric center point of the region, a point adjacent to the geometric center point of the region, or a point in the region suitable for measurement, N may be greater than 25, equal to 25 or smaller than 25. Since the N sensors of the sensor array can measure at the same time; hence, the scanning speed is very fast and a lot of time and cost can be saved.

In some embodiments, in the Step B of the method for laser processing wafer surface of the present invention, the top surface 60 of the wafer 6 can be completely scanned by the scanning device 3 to obtain the complete profile distribution of the top surface 60 of the wafer 6. In some other embodiments, in the Step B of the method for laser processing wafer surface of the present invention, the top surface 60 of the wafer 6 can be chosen to be partially scanned by the scanning device 3 to obtain the profile distribution of the top surface 60 of the wafer 6. In some other embodiments, in the Step B of the method for laser processing wafer surface of the present invention, the top surface 60 of the wafer 6 can be chosen to be scanned roughly as shown in the embodiment of FIG. 17 by the scanning device 3 to obtain the profile distribution of the top surface 60 of the wafer 6. Whether it is a complete or partial scanning, or a fine or rough scanning, it all depends on the actual needs.

As disclosed in the above description and attached drawings, the present invention can provide a laser processing system for wafer surface and the method thereof. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A method for laser processing wafer surface, comprising following steps of:
Step A: providing a wafer;
Step B: performing profile scanning a top surface of the wafer by a scanning device to obtain a profile distribution of the top surface of the wafer; and
Step C: performing laser processing on the wafer from the top surface of the wafer by a laser apparatus with a fluence integration distribution to form a laser-processed wafer, wherein the fluence integration distribution is related to the profile distribution of the top surface of the wafer.

2. The method for laser processing wafer surface according to claim 1, wherein the fluence integration distribution and the profile distribution meet one of the following conditions: (1) the first condition: where the profile distribution is higher, the fluence integration distribution is approximately higher, (2) the second condition: the profile distribution has a maximum value and a minimum value, a difference of the maximum value and the minimum value is defined as a high-low range of the profile distribution, a difference of the profile distribution and the minimum value is defined as a normalized profile distribution, a ratio of the normalized profile distribution to the high-low range is defined as a normalized-profile proportion distribution, wherein the fluence integration distribution is approximately proportional to the normalized-profile proportion distribution, (3) the third condition: where the profile distribution is smaller than or equal to a minimum height threshold, the fluence integration distribution is approximately equal to a minimum fluence integration threshold, wherein the minimum fluence integration threshold is greater than or equal to zero, (4) the fourth condition: where the profile distribution is smaller than or equal to a minimum height threshold, the fluence integration distribution is approximately equal to a minimum fluence integration threshold, wherein the minimum fluence integration threshold is greater than or equal to zero; while the profile distribution is greater than the minimum height threshold, where the profile distribution is higher, the fluence integration distribution is approximately higher, (5) the fifth condition: where the profile distribution is higher, the fluence integration distribution is approximately lower, and (6) the sixth condition: the profile distribution has a maximum value and a minimum value, a difference of the maximum value and the minimum value is defined as a high-low range of the profile distribution, a difference of the profile distribution and the minimum value is defined as a normalized profile distribution, a ratio of the normalized profile distribution to the high-low range is defined as a normalized-profile proportion distribution, wherein the fluence integration distribution is approximately inversely proportional to the normalized-profile proportion distribution.

3. The method for laser processing wafer surface according to claim 2, wherein the fluence integration distribution is capable of being controlled by controlling at least one of a laser pulse integration distribution and a fluence of the laser apparatus.

4. The method for laser processing wafer surface according to claim 1, wherein the fluence integration distribution is capable of being controlled by controlling at least one of a laser pulse integration distribution and a fluence of the laser apparatus.

5. The method for laser processing wafer surface according to claim 4, wherein the laser pulse integration distribution is capable of being controlled by controlling at least one of an overlapping rate of a plurality of laser pulses generated by the laser apparatus along a laser processing path direction and an overlapping rate of the plurality of laser pulses generated by the laser apparatus along a separation direction of two adjacent laser processing paths.

6. The method for laser processing wafer surface according to claim 4, wherein the fluence of the laser apparatus is greater than or equal to a minimum fluence threshold.

7. The method for laser processing wafer surface according to claim 6, wherein the minimum fluence threshold is at least related to a wavelength of the laser apparatus and a material that the wafer is made of.

8. The method for laser processing wafer surface according to claim 4, wherein the fluence of the laser apparatus is capable of being controlled by controlling at least one of a pulse repetition rate of the laser apparatus, a power of the laser apparatus and a spot area of a laser pulse generated by the laser apparatus on a focal plane of the laser pulse.

9. The method for laser processing wafer surface according to claim 1, wherein before the Step C, the method further comprises a following step of: coating an assisted modifying layer on the top surface of the wafer.

10. The method for laser processing wafer surface according to claim 9, wherein the assisted modifying layer is made of at least one material selected from the group consisting of: (1) a mixture of a solution containing metal ions, an oxidant and a buffer, (2) an alkaline solution or colloid, and (3) at least one of a sol-gel containing at least one metal and a sol-gel containing an oxide of the at least one metal.

11. The method for laser processing wafer surface according to claim 10, wherein the assisted modifying layer is made of the mixture of the solution containing metal ions, the oxidant and the buffer; wherein the solution containing metal ions is made of at least one material selected from the group consisting of: a solution of Ag³⁺ ions and a solution of Cu²⁺ ions; wherein the oxidant is hydrogen peroxide; wherein the buffer is glacial acetic acid.

12. The method for laser processing wafer surface according to claim 10, wherein the assisted modifying layer is made of the alkaline solution or colloid, wherein the alkaline solution or colloid is made of at least one material selected from the group consisting of: potassium hydroxide and ammonia.

13. The method for laser processing wafer surface according to claim 10, wherein the assisted modifying layer is made of at least one of the sol-gel containing the at least one metal and the sol-gel containing the oxide of the at least one metal, wherein the at least one metal is at least one of Al, B, Ga and In, wherein the oxide of the at least one metal is at least one of aluminum oxide, boron oxide, gallium oxide and indium oxide.

14. The method for laser processing wafer surface according to claim 1, wherein after the Step C, the method further comprises a following step of: polishing a top surface of the laser-processed wafer.

15. The method for laser processing wafer surface according to claim 1, wherein in the Step C, at least one portion of the wafer adjacent to the top surface of the wafer is removed, such that the wafer is at least partially planarized.

16. The method for laser processing wafer surface according to claim 15, wherein the at least one portion of the wafer been removed is where the profile distribution of the top surface of the wafer is higher.

17. The method for laser processing wafer surface according to claim 1, wherein in the Step C, a portion of the wafer adjacent to the top surface of the wafer is removed, such that the wafer is globally planarized.

18. The method for laser processing wafer surface according to claim 1, wherein the laser apparatus is at least one of a diode pumped solid state laser apparatus, a gas laser apparatus, a semiconductor laser apparatus and a fiber laser apparatus.

19. The method for laser processing wafer surface according to claim 1, wherein the wafer is made of at least one material selected from the group consisting of: SiC, Ga₂O₃, sapphire, InP, GaAs, diamond, GaN, GaP, quartz, Si, AlN, InAs, SiGe, germanium and ceramic.

20. A laser processing system for wafer surface, comprising:
a motion driving apparatus;
a carrying device disposed on the motion driving apparatus, the carrying device is used for carrying a wafer;
a scanning device, wherein the motion driving apparatus enables at least one of a relative displacement and a relative rotation between the scanning device and the wafer, the scanning device is used for scanning a top surface of the wafer to obtain a profile distribution of the top surface of the wafer; and
a laser apparatus, wherein the laser apparatus is used for performing laser processing on the wafer from the top surface of the wafer with a fluence integration distribution to form a laser-processed wafer, wherein the fluence integration distribution is related to the profile distribution of the top surface of the wafer.

21. The laser processing system for wafer surface according to claim 20, wherein the fluence integration distribution and the profile distribution meet one of the following conditions: (1) the first condition: where the profile distribution is higher, the fluence integration distribution is approximately higher, (2) the second condition: the profile distribution has a maximum value and a minimum value, a difference of the maximum value and the minimum value is defined as a high-low range of the profile distribution, a difference of the profile distribution and the minimum value is defined as a normalized profile distribution, a ratio of the normalized profile distribution to the high-low range is defined as a normalized-profile proportion distribution, wherein the fluence integration distribution is approximately proportional to the normalized-profile proportion distribution, (3) the third condition: where the profile distribution is smaller than or equal to a minimum height threshold, the fluence integration distribution is approximately equal to a minimum fluence integration threshold, wherein the minimum fluence integration threshold is greater than or equal to zero, (4) the fourth condition: where the profile distribution is smaller than or equal to a minimum height threshold, the fluence integration distribution is approximately equal to a minimum fluence integration threshold, wherein the minimum fluence integration threshold is greater than or equal to zero; while the profile distribution is greater than the minimum height threshold, where the profile distribution is higher, the fluence integration distribution is approximately higher, (5) the fifth condition: where the profile distribution is higher, the fluence integration distribution is approximately lower, and (6) the sixth condition: the profile distribution has a maximum value and a minimum value, a difference of the maximum value and the minimum value is defined as a high-low range of the profile distribution, a difference of the profile distribution and the minimum value is defined as a normalized profile distribution, a ratio of the normalized profile distribution to the high-low range is defined as a normalized-profile proportion distribution, wherein the fluence integration distribution is approximately inversely proportional to the normalized-profile proportion distribution.

22. The laser processing system for wafer surface according to claim 20, wherein the motion driving apparatus comprises a scanning motion driving device, the carrying device comprises a scanning wafer carrier disposed on the scanning motion driving device; wherein the scanning motion driving device enables at least one of a relative displacement and a relative rotation between the scanning device and the wafer when the wafer is carried by the scanning wafer carrier.

23. The laser processing system for wafer surface according to claim 22, wherein the motion driving apparatus further comprises a processing motion driving device, the carrying device further comprises a processing wafer carrier disposed on the processing motion driving device; wherein the processing motion driving device enables at least one of a relative displacement and a relative rotation between the laser apparatus and the wafer when the wafer is carried by the processing wafer carrier.

24. The laser processing system for wafer surface according to claim 20, further comprising a coating device, the coating device comprises a coating wafer carrier, the coating device is used for carrying the wafer by the coating wafer carrier and coating an assisted modifying layer on the top surface of the wafer before performing laser processing on the wafer by the laser apparatus.

25. The laser processing system for wafer surface according to claim 24, wherein the assisted modifying layer is made of at least one material selected from the group consisting of: (1) a mixture of a solution containing metal ions, an oxidant and a buffer, (2) an alkaline solution or colloid, and (3) at least one of a sol-gel containing at least one metal and a sol-gel containing an oxide of the at least one metal.

26. The laser processing system for wafer surface according to claim 25, wherein the assisted modifying layer is made of the mixture of the solution containing metal ions, the oxidant and the buffer; wherein the solution containing metal ions is made of at least one material selected from the group consisting of: a solution of Ag³⁺ ions and a solution of Cu²⁺ ions; wherein the oxidant is hydrogen peroxide; wherein the buffer is glacial acetic acid.

27. The laser processing system for wafer surface according to claim 25, wherein the assisted modifying layer is made of the alkaline solution or colloid, wherein the alkaline solution or colloid is made of at least one material selected from the group consisting of: potassium hydroxide and ammonia.

28. The laser processing system for wafer surface according to claim 25, wherein the assisted modifying layer is made of at least one of the sol-gel containing the at least one metal and the sol-gel containing the oxide of the at least one metal, wherein the at least one metal is at least one of Al, B, Ga and In, wherein the oxide of the at least one metal is at least one of aluminum oxide, boron oxide, gallium oxide and indium oxide.

29. The laser processing system for wafer surface according to claim 20, wherein the laser apparatus is at least one of a diode pumped solid state laser apparatus, a gas laser apparatus, a semiconductor laser apparatus and a fiber laser apparatus.

30. The laser processing system for wafer surface according to claim 20, wherein the scanning device is one of a line scanner, a plane scanner, a height sensor, a distance sensor and a 3D scanner.
